(19) United States
(12) Patent Application Publication
(10) Pub. No.: US 2024/0316529 A1
(43) Pub. Date: Sep. 26, 2024

(54) FORMED ADSORBER FOR CANISTER

(71) Applicants: NIPPON PAPER INDUSTRIES CO., LTD., Tokyo (JP); FUTABA INDUSTRIAL CO., LTD., Aichi (JP)

(72) Inventors: Yoshihide Watanabe, Tokyo (JP); Dongyeon Ryu, Tokyo (JP); Minoru Yada, Tokyo (JP); Takuya Nakagawa, Aichi (JP); Shogo Minezawa, Aichi (JP); Masahito Hosoi, Aichi (JP); Koji Iwamoto, Aichi (JP); Kyohei Yamaguchi, Aichi (JP); Tamami Ina, Aichi (JP)

(73) Assignees: NIPPON PAPER INDUSTRIES CO., LTD., Tokyo (JP); FUTABA INDUSTRIAL CO., LTD., Aichi (JP)

(21) Appl. No.: 18/610,677

(22) Filed: Mar. 20, 2024

(30) Foreign Application Priority Data
Mar. 23, 2023 (JP) 2023-046221

(51) Int. Cl. B01J 20/20; B01J 20/28

(52) U.S. Cl. CPC B01J 20/20; B01J 20/28023; B01J 20/2803; B01J 20/28066; B01J 20/28073; B01J 20/28076; B01J 20/28083; B01J 2220/42; B01J 2220/66

(57) ABSTRACT

A problem is to provide a formed adsorber having excellent adsorption and desorption performance for fuel vapor (in particular, n-butane) of a wide concentration range from a low concentration to a high concentration.

A formed product including activated carbon fiber, granular activated carbon, and a binder is prepared. A weight ratio of the activated carbon fiber to the granular activated carbon is 5 to 95 parts by weight of the activated carbon fiber to 95 to 5 parts by weight of the granular activated carbon, in a total weight of the activated carbon fiber and the granular activated carbon, a content ratio of the binder in the formed adsorber is 0.3 to 20 parts by weight of the binder to 100 parts by weight of the activated carbon fiber and the granular activated carbon, the granular activated carbon has a total pore volume ranging from 0.90 to 2.50 cm³/g, and the activated carbon fiber has a total pore volume ranging from 0.50 to 1.20 cm³/g.

### CROSS-REFERENCE TO RELATED APPLICATIONS

This application is based upon and claims the benefit of priority from Japanese Patent Application No. 2023-046221, filed Mar. 23, 2023, the entire contents of which are incorporated herein by reference.

### TECHNICAL FIELD

The present disclosure relates to a formed adsorber suitable for canister, and particularly relates to a formed adsorber for canisters, the formed adsorber using activated carbon.

### BACKGROUND ART

Pressure in fuel tanks of vehicles changes as outside air temperature changes, for example, and fuel vapor that has filled the fuel tanks is released from the fuel tanks. These vehicles include motor vehicles, motorbikes (motorcycles), and boats, and have internal-combustion engines for combustion of fuel vapor, such as gasoline. The released fuel vapor is considered to be one of substances contributing to PM2.5 or photochemical smog. Canisters (also called fuel vapor restraining devices) including adsorbing materials, such as activated carbon, have been provided to prevent the release of the fuel vapor into the atmosphere.

With the recent increase in awareness for environmental conservation, various gas emission regulations tend to be tightened year by year and there is thus a demand for canisters to have higher adsorption performance. Furthermore, intake performance of motor vehicles tends to be reduced due to the spread of start-stop systems, for example, and gasoline adsorbed by adsorbing materials in their canisters thus tends to be difficult to be desorbed. Therefore, there is a demand for adsorbing materials used in canisters to have even higher performance. Activated carbon is often used as an adsorbing material to be used in canisters, and as to its shape, granular activated carbon and activated carbon that has been molded into a pellet shape or a honeycomb shape have been proposed, for example (for example, Patent Literature 1.)

Furthermore, in recent years, for improvement of the performance of canisters, more canisters have an adsorbing material stored in more than one chamber by each being provided with a main chamber and an auxiliary chamber, for example (Patent Literature 2, for example).

An activated carbon fiber sheet having given characteristics has been proposed as one of adsorbing materials suitable for canisters (for example, Patent Literature 3). An activated carbon fiber sheet having excellent adsorption and desorption performance for a low concentration of fuel vapor (mainly n-butane) has been disclosed in Patent Literature 3.

Furthermore, an activated carbon fiber formed adsorber including activated carbon fiber and fibrillated cellulose fiber that has resistance to alkali has been proposed for improvement of mechanical strength and filling density of formed adsorbers using activated carbon fiber (for example, Patent Literature 4).

Furthermore, a fuel vapor emission control system that enables reduction of diurnal breathing loss (DBL) emission to 20 mg or less by use of a comparatively low purge volume has been proposed, the purge volume being determined by use of Bleed Emissions Test Procedure (BETP) (for example, Patent Literature 5).

Activated carbon fiber (or fibrous activated carbon) is sometimes called the third activated carbon in contrast with conventional powdered or granular activated carbon. Among activated carbon in a broad sense, activated carbon fiber is said to have micropores that are directly open at the outer surface of the activated carbon fiber and to have a tendency to be high in adsorption and desorption speed. However, for use of activated carbon fiber in canisters, research and development have not advanced sufficiently yet as to characteristics of activated carbon fiber suitable for practical use in canisters. In particular, there is still room for development with respect to improving performance of mixed adsorbing materials including granular activated carbon and activated carbon fiber. As mentioned above, an activated carbon fiber sheet having excellent adsorption and desorption performance for a low concentration of fuel vapor has been proposed in Patent Literature 3, for example, but there has still been a demand for an adsorbing material having excellent adsorption and desorption performance for a wider range from a low concentration to a high concentration of fuel vapor.

### CITATION LIST

### Patent Literature

Patent Literature 1: Japanese Patent Application Laid-open No. 2013-173137
Patent Literature 2: Japanese Patent Application Laid-open No. 2019-108880
Patent Literature 3: Japanese Patent No. 6568328
Patent Literature 4: Japanese Patent Application Laid-open No. H10-005580
Patent Literature 5: Japanese National Publication of International Patent Application No. 2016-053354

### SUMMARY OF INVENTION

In view of the foregoing, a problem to be solved is to provide a formed adsorber having excellent adsorption and desorption performance for a wide range of concentration, from a low concentration to a high concentration, of fuel vapor (for example, n-butane).

Furthermore, in another aspect, another problem to be solved is to provide a formed adsorber having excellent adsorption performance for fuel vapor (for example, n-butane) having a wide range of concentration from a low concentration to a high concentration, the formed adsorber also having excellent recovery performance by enabling highly efficient desorption with purging air for canisters.

As a result of diligent research, the present inventors have successfully derived excellent performance of an adsorbing material in the form of a formed product including, in addition to a combination of plural types of given activated carbon having different characteristics, a binder. The present disclosure proposes a formed adsorber including at least two or more types of activated carbon, specifically, adsorbing materials that are at least two types of activated carbon having different characteristics, activated carbon fiber and granular activated carbon.

The invention presented by the present disclosure can be understood versatilely through various aspects and, for example, may include embodied aspects as solutions to the problems, as follows. In the present disclosure, the invention presented by the present disclosure may simply be referred as to “the present invention” comprehensively and conceptually or according to the individual aspects.

[1] A formed adsorber for a canister, the formed adsorber comprising:
activated carbon fiber, granular activated carbon, and a binder, the formed adsorber being a formed product;
a weight ratio that is 5 to 95 parts by weight of the activated carbon fiber to 95 to 5 parts by weight of the granular activated carbon, in a total weight of the activated carbon fiber and the granular activated carbon;
a content ratio of 0.3 to 20 parts by weight of the binder in the formed adsorber to 100 parts by weight of the activated carbon fiber and the granular activated carbon;
the granular activated carbon having a total pore volume ranging from 0.90 to 2.50 cm³/g; and
the activated carbon fiber having a total pore volume ranging from 0.50 to 1.20 cm³/g.

[2] The formed adsorber according to [1] above, wherein the granular activated carbon has a mean pore diameter ranging from 2.00 to 4.00 nm.

[3] The formed adsorber according to [1] or [2] above, wherein the granular activated carbon has a specific surface area ranging from 1400 to 2700 m²/g.

[4] The formed adsorber according to any one of [1] to [3] above, wherein
the granular activated carbon has a mean pore diameter ranging from 2.00 to 4.00 nm, and
the granular activated carbon has a specific surface area ranging from 1400 to 2700 m²/g.

[5] The formed adsorber according to any one of [1] to [4] above, wherein
the total pore volume of the activated carbon fiber is smaller than the total pore volume of the granular activated carbon, and
the activated carbon fiber has a mean pore diameter smaller than a/the mean pore diameter of the granular activated carbon.

[6] The formed adsorber according to [1] above, wherein
the granular activated carbon has a mean pore diameter ranging from 2.00 to 4.00 nm,
the granular activated carbon has a specific surface area ranging from 1400 to 2700 m²/g,
the total pore volume of the activated carbon fiber is smaller than the total pore volume of the granular activated carbon, and
the activated carbon fiber has a mean pore diameter smaller than the mean pore diameter of the granular activated carbon.

[7] The formed adsorber according to any one of [1] to [6] above, wherein the formed adsorber has a total pore volume ranging from 0.90 to 2.00 cm³/g.

[8] The formed adsorber according to any one of [1] to [7] above, wherein the formed adsorber has a mean pore diameter ranging from 1.87 to 4.00 nm.

[9] The formed adsorber according to any one of [1] to [8] above, wherein the weight ratio of the activated carbon fiber to the granular activated carbon, in the total weight of the activated carbon fiber and the granular activated carbon is 5 to 70 parts by weight of the activated carbon fiber to 95 to 30 parts by weight of the granular activated carbon.

[10] The formed adsorber according to any one of [1] to [9] above, wherein
an effective adsorption-desorption ratio for 100% n-butane is 75.0% or more, and
an effective adsorption-desorption ratio for 0.2% n-butane is 60.0% or more.

[11] The formed adsorber according to any one of [1] to above, wherein an/the effective adsorption-desorption ratio for 100% n-butane is 81.0% or more.

[12] The formed adsorber according to any one of [1] to above, wherein an/the effective adsorption-desorption ratio for 0.2% n-butane is 70.0% or more.

[13] The formed adsorber according to any one of [1] to above, wherein the binder is a fibrous binder.

One or more aspects of the invention presented in the present disclosure enable provision of an adsorbing material having excellent adsorption and desorption performance for fuel vapor (for example, n-butane) from a low concentration to a high concentration.

Furthermore, one or more aspects of the invention presented in the present disclosure provide an adsorbing material having excellent adsorption performance for fuel vapor (for example, n-butane) from a low concentration to a high concentration and having excellent recovery performance by enabling highly efficient desorption with purging air for canisters.

### BRIEF DESCRIPTION OF DRAWINGS

FIG. 1 is a diagram schematically illustrating an example of a layered adsorber having plural sheet-shaped formed adsorbers layered over one another and an example of a flow direction of fluid that passes through the layered adsorber.

FIG. 2 is a diagram illustrating an example of an adsorber that has been formed in a disk shape.

FIG. 3 is a diagram illustrating an example of an adsorber that has been formed in a cylinder shape.

### DESCRIPTION OF EMBODIMENTS

Embodiments of the present invention will be described hereinafter.

As used herein, “a” or “an” may mean one or more. As used herein when used in conjunction with the word “comprising,” the words “a” or “an” may mean one or more than one. As used herein “another” may mean at least a second or more. Furthermore, unless otherwise required by context, singular terms include pluralities and plural terms include the singular.

In the present disclosure, unless otherwise specified, the term, “an embodiment,” in relation to the present invention refers to an optional embodiment for description of the present invention in detail and does not deny or limit the presence of any other embodiment or plural embodiments. As described hereinafter, plural embodiments may be included in the scope of the present invention. The plural embodiments may be provided, for example, in modified forms through combination of components (or technical features) disclosed herein in various ways. Furthermore, “embodiments” simply referred to in the present disclosure include, unless otherwise specified, one or plural embodiments.

In the present disclosure, the phrase, “ranging from AA to BB,” in relation to a numerical range means “being in the range of AA or more and BB or less,” (where “AA” and “BB” represent any numerical values) unless otherwise specified. Furthermore, the units of the lower limit and the upper limit are the same as the unit written immediately after the upper limit (that is, “BB” herein), unless otherwise specified. Furthermore, in the present disclosure, any combination of numerical values can be selected, as a combination of a lower limit and an upper limit of a numerical range, from the groups of numerical values of the lower limits or upper limits exemplarily described as preferable numerical values, for example. Furthermore, the phrase, “X and/or Y,” means both of X and Y or any one of X and Y.

In the present disclosure, the term, “pore size,” means the diameter or width of a pore, rather than the radius of the pore, unless otherwise stated clearly. That is, in the present disclosure, the term, “pore size,” is synonymous with “pore diameter,” unless otherwise stated clearly.

### 1. Formed Adsorber for Canister

A formed adsorber in an embodiment of the present invention can be used suitably in canisters. A canister is a piece of equipment that includes an adsorbing material and has a role in reducing vaporized fuel vapor released into the atmosphere by letting the vaporized fuel vapor be adsorbed by the adsorbing material and supplying fuel vapor to an engine by letting the fuel vapor, which has been adsorbed by the adsorbing material, be desorbed when the engine is operating. Canisters are generally used in machines or equipment including internal-combustion engines that use fuels including highly volatile hydrocarbons, for example, in vehicles and vessels that include internal-combustion engines. Examples of these vehicles include motor vehicles that use gasoline as a fuel. Examples of these vessels include boats that use gasoline as a fuel.

In an embodiment of the present invention, the formed adsorber includes activated carbon fiber, granular activated carbon, and a binder. The activated carbon fiber and the granular activated carbon correspond to adsorbing materials. A preferred embodiment may be a formed product of a mixture of the activated carbon fiber, the granular activated carbon, and the binder. Furthermore, another preferred embodiment of the formed adsorber may be a layered structure having plural sheets connected to each other by use of the binder, the plural sheets each having the granular activated carbon adhered to or held on a surface of an activated carbon fiber sheet.

In an embodiment of the present invention, a weight ratio of the activated carbon fiber to the granular activated carbon may be 5 to 95 parts by weight of the activated carbon fiber to 95 to 5 parts by weight of the granular activated carbon in a total weight of the activated carbon fiber and the granular activated carbon. In other words, preferably 5 parts by weight or more and 95 parts by weight or less of the activated carbon fiber are included and preferably 5 parts by weight or more and 95 parts by weight or less of the granular activated carbon are included, in 100 parts by weight of the activated carbon fiber and the granular activated carbon that are contained in the formed adsorber. The following is an example of specific numerical values. For example, the formed adsorber having a total content of 10 grams of the activated carbon fiber and the granular activated carbon may include 5 grams (50 parts by weight) of the activated carbon fiber and 5 grams (50 parts by weight) of the granular activated carbon.

The weight ratio depends on what kind of performance is demanded for the formed adsorber, and for example, with the objective of placing importance on adsorption and desorption performance for fuel vapor (in particular, n-butane) of a wide concentration range from a low concentration to a high concentration, the weight ratio of the activated carbon fiber to the granular activated carbon (activated carbon fiber: granular activated carbon) may be preferably 5 to 95 parts by weight: 95 to 5 parts by weight, more preferably 5 to 70 parts by weight: 95 to 30 parts by weight, and even more preferably 5 to 45 parts by weight: 95 to 55 parts by weight, 5 to 40 parts by weight: 95 to 60 parts by weight, or 5 to 35 parts by weight: 95 to 65 parts by weight. The following is an example of specific numerical values. For example, the formed adsorber having a total content of 10 grams of the activated carbon fiber and the granular activated carbon may include 2 grams (20 parts by weight) of the activated carbon fiber and 8 grams (80 parts by weight) of the granular activated carbon.

The following description is on individual preferable contents of the activated carbon fiber and the granular activated carbon, with the objective of placing importance on adsorption and desorption performance for fuel vapor (in particular, n-butane) of a wide concentration range from a low concentration to a high concentration.

The upper limit of the content of the activated carbon fiber in the formed adsorber may be preferably 95 parts by weight or less, more preferably 70 parts by weight or less, and even more preferably 45, 40, or 35 parts by weight or less, in 100 parts by weight of the total of the activated carbon fiber and the granular activated carbon. Furthermore, the lower limit of the content of the activated carbon fiber in the formed adsorber may be preferably 5, 8, or 10 parts by weight or more, in 100 parts by weight of the total of the activated carbon fiber and the granular activated carbon.

The upper limit of the content of the granular activated carbon in the formed adsorber, on the other hand, may be preferably 95, 92, or 90 parts by weight or less, in 100 parts by weight of the total of the activated carbon fiber and the granular activated carbon. Furthermore, the lower limit of the content of the granular activated carbon in the formed adsorber may be preferably 5 parts by weight or more, more preferably 30 parts by weight or more, and even more preferably 55, 60, or 65 parts by weight or more, in 100 parts by weight of the total of the activated carbon fiber and the granular activated carbon.

As described above, in an embodiment of the present invention, activated carbon fiber and granular activated carbon are used as components of a formed adsorber. Various embodiments of the activated carbon fiber and the granular activated carbon will be described more in detail later.

In an embodiment of the present invention, the binder is used as a component of the formed adsorber. The binder that may be used is preferably a binder that does not easily block pores of the activated carbon fiber and the activated carbon and examples of a material for the binder include polyvinyl alcohol. Furthermore, preferred examples of the binder may include fibrous binders. The fibrous binders are not particularly limited as long as the activated carbon fiber and the granular activated carbon can be entangled and shaped by fibrillation. A wide range of binders including synthetic binders and naturally occurring binders can be used. Examples of the fibrous binder may include acrylic fiber, polyethylene fiber, polypropylene fiber, polyacrylonitrile fiber, cellulose fiber, nylon fiber, and aramid fiber.

In an embodiment of the present invention, a content ratio of the binder in the formed adsorber may be 0.3 to 20 parts by weight, to 100 parts by weight of the activated carbon fiber and the granular activated carbon that are contained in the formed adsorber. More specifically, the content ratio is as follows.

The lower limit of the content ratio of the binder may be preferably 0.3, 0.5, 0.8, 1.0, 2.0, or 3.0 parts by weight.

The upper limit of the content ratio of the binder may be preferably 20, 18, 15, or 10 parts by weight.

The following is an example of specific numerical values. For example, the formed adsorber having a total content of 10 grams of the activated carbon fiber and the granular activated carbon may have 0.03 grams to 2 grams of the binder added therein. Therefore, in this case, the total weight of the activated carbon fiber, the granular activated carbon, and the binder in the formed product ranges from 10.03 g to 12.0 g.

Adding the binder at the above content ratio enables preparation of the formed adsorber having both mechanical strength and adsorption and desorption performance. If higher mechanical strength is desired, the amount of the binder may be increased and if adsorption and desorption performance is considered to be important, the amount of the binder may be set low. Furthermore, having such a content may be preferable for obtainment of a formed adsorber achieving less pressure loss.

The activated carbon fiber is preferably mixed as fiber in a defibrillated state. Mixing the activated carbon fiber as fiber in the defibrillated state with components, such as the granular activated carbon and the binder enables the components to be entangled with one another, thus improving connection and mechanical strength of the formed product and obtaining a formed product that is more difficult to be deformed.

In other various embodiments of the present invention, fulfilling one or any two or more of the following given conditions may enable more preferable formed adsorbers for canisters to be obtained. Preferred combinations of the following given conditions can be optionally selected as desired according to requirements demanded, for example.

### Total Pore Volume of Formed Adsorber

In an embodiment of the present invention, the formed adsorber may preferably have a total pore volume of 0.90 to 2.00 cm³/g or less. More specifically, the total pore volume is as follows.

In an embodiment of the present invention, the lower limit of the total pore volume of the formed adsorber may be preferably 0.90 cm³/g or more, more preferably 0.98 or 1.00 cm³/g or more, and even more preferably 1.05 or 1.10 cm³/g or more.

In an embodiment of the present invention, the lower limit of the total pore volume of the formed adsorber may be preferably 2.00 cm³/g or less, more preferably 1.80 cm³/g or less, and even more preferably 1.50 cm³/g or less.

Setting the total pore volume in the above range is suitable for obtaining a formed adsorber having excellent adsorption and desorption performance for fuel vapor (in particular, n-butane) of a wide concentration range from a low concentration to a high concentration. Setting the total pore volume in the above range is also suitable in terms of obtaining a formed adsorber enabling reduction of pressure loss.

### Mean Pore Size (Mean Pore Diameter) of Formed Adsorber

In an embodiment of the present invention, the formed adsorber may preferably have a mean pore size ranging from 1.87 to 4.00 nm. More specifically, the mean pore size is as follows.

In an embodiment of the present invention, the lower limit of the mean pore size of the formed adsorber may be preferably 1.87 nm or more, more preferably 1.90 nm or more, and even more preferably 2.00 nm or more.

In an embodiment of the present invention, the upper limit of the man pore size of the formed adsorber may be optional but may be preferably 4.00 nm or less, more preferably 3.00 nm or less, and even more preferably 2.50 nm or less.

Setting the mean pore size in the above range is suitable for obtaining a formed adsorber having excellent adsorption and desorption performance for fuel vapor (in particular, n-butane) of a wide concentration range from a low concentration to a high concentration.

### Specific Surface Area of Formed Adsorber

In an embodiment of the present invention, the formed adsorber may have a specific surface area of 1400 to 2500 m²/g or less. More specifically, the specific surface area is as follows.

In an embodiment of the present invention, the lower limit of the specific surface area of the formed adsorber may be preferably 1400 or 1410 m²/g or more, more preferably 1450, 1460, or 1480 m²/g or more, and even more preferably 1490 or 1500 m²/g or more.

In an embodiment of the present invention, the upper limit of the specific surface area of the formed adsorber may generally be 2500, 2400 or 2300 m²/g or less, although a large specific surface area is generally preferable in terms of adsorption and desorption performance.

Setting the specific surface area in the above range enables the formed adsorber to have better adsorption and desorption performance for fuel vapor (in particular, n-butane). Furthermore, in an embodiment of the present invention, reduction of pressure loss in a canister may be achieved with a comparatively large specific surface area maintained for the above described adsorbing material used in the canister.

### Ultramicropore Volume of Formed Adsorber V_{0.7}

In the present disclosure, the term, “ultramicropore,” means a pore having a pore size of 0.7 nm or less.

In an embodiment of the present invention, the formed adsorber may preferably have an ultramicropore volume ranging from 0.05 to 0.30 cm³/g. More specifically, the ultramicropore volume is as follows.

In an embodiment of the present invention, the lower limit of the ultramicropore volume of the formed adsorber may be preferably 0.05 cm³/g or more, more preferably 0.08 cm³/g or more, and even more preferably 0.10 cm³/g or more.

In an embodiment of the present invention, the upper limit of the ultramicropore volume of the formed adsorber may be preferably 0.30 cm³/g or less, more preferably 0.29 cm³/g or less, and even more preferably 0.26, 0.24, 0.22, or 0.20 cm³/g or less.

Setting the ultramicropore volume in the above range is suitable for obtaining a formed adsorber that is excellent in terms of adsorption and desorption performance and pressure loss, for example.

### Micropore Volume of Formed Adsorber: V_{2.0}

In the present disclosure, the term, “micropore,” means a pore having a pore size of 2.0 nm or less.

In an embodiment of the present invention, the formed adsorber may preferably have a micropore volume ranging from 0.50 to 1.00 cm³/g. More specifically, the micropore volume is as follows.

In an embodiment of the present invention, the lower limit of the micropore volume of the formed adsorber may be preferably 0.50 cm³/g or more, more preferably 0.55 or 0.58 cm³/g or more, and even more preferably 0.59 or 0.60 cm³/g or more.

In an embodiment of the present invention, the upper limit of the micropore volume of the formed adsorber may be 1.00 cm³/g or less, more preferably 0.90 cm³/g or less, and even more preferably 0.80 cm³/g or less.

Setting the micropore volume in the above range is suitable for obtaining a formed adsorber that is excellent in terms of adsorption and desorption performance and pressure loss, for example.

Pore Volume of Pores Having Pore Size Larger than 0.7 nm and Equal to or Smaller than 2.0 nm: V_{0.7-2.0}

A pore volume V_{0.7-2.0} of pores having pore sizes larger than 0.7 nm and equal to or smaller than 2.0 nm can be determined by Equation 1 below using a value “a” of ultramicropore volume and a value “b” of micropore volume.

$${V}_{0.7 - 2.0} = b - a \qquad ( Equation 1 )$$

In an embodiment of the present invention, the formed adsorber may preferably have a pore volume V_{0.7-2.0} ranging from 0.30 to 1.00 cm³/g, the pore volume V_{0.7-2.0} being a pore volume of pores having pore sizes larger than 0.7 nm and equal to or smaller than 2.0 nm. More specifically, the pore volume V_{0.7-2.0} is as follows.

In an embodiment of the present invention, the lower limit of the pore volume V_{0.7-2.0} of the pores having the pore sizes larger than 0.7 nm and equal to or smaller than 2.0 nm in the formed adsorber may be preferably 0.30 cm³/g or more, more preferably 0.36 cm³/g or more, and even more preferably 0.38, 0.40, or 0.43 cm³/g or more.

In an embodiment of the present invention, the upper limit of the pore volume V_{0.7-2.0} of the pores having the pore sizes larger than 0.7 nm and equal to or smaller than 2.0 nm in the formed adsorber may be preferably 1.00 cm³/g or less, more preferably 0.90 cm³/g or less, and even more preferably 0.80, 0.75, 0.70, 0.65, or 0.60 cm³/g or less.

Setting the pore volume V_{0.7-2.0} in the above range is suitable for obtaining a formed adsorber that is excellent in terms of adsorption and desorption performance and pressure loss, for example.

### Ratio of Volume of Ultramicropores to Volume of Micropores: R_{0.7/2.0}

A ratio R_{0.7/2.0} of a pore volume of ultramicropores having pore sizes of 0.7 nm or less to a pore volume of micropores having pore sizes of 2.0 nm or less can be determined by Equation 2 below using the value “a” of the ultramicropore volume and the value “b” of the micropore volume.

$${R}_{0.7 / 2.0} = a / b \times 100 ( \% ) \qquad ( Equation 2 )$$

In an embodiment of the present invention, the formed adsorber may preferably have a ratio R_{0.7/2.0} ranging from 10.0 to 60.0%, the ratio R_{0.7/2.0} being a ratio of an ultramicropore volume to a micropore volume. More specifically, the ratio R_{0.7/2.0} is as follows.

In an embodiment of the present invention, the lower limit of the ratio R_{0.7/2.0} of the ultramicropore volume to the micropore volume in the formed adsorber may be preferably 10.0% or more, more preferably 13.0% or more, and even more preferably 15.0% or more.

In an embodiment of the present invention, the upper limit of the ratio R_{0.7/2.0} of the ultramicropore volume to the micropore volume in the formed adsorber may be preferably 60.0% or less, more preferably 50% or less, and even more preferably 40, 30, or 25% or less.

Setting the ratio R_{0.7/2.0} of the ultramicropore volume in the above range is suitable for obtaining a formed adsorber that is excellent in terms of adsorption and desorption performance and pressure loss, for example.

### Dry Density of Formed Adsorber

In an embodiment of the present invention, the formed adsorber may preferably have a dry density ranging from 0.010 to 0.400 g/cm³. More specifically, the dry density is as follows.

The lower limit and upper limit of the dry density of the formed adsorber that is an embodiment of the present invention may be as follows.

The lower limit of the dry density of the formed adsorber may be preferably 0.010 g/cm³ or more, more preferably 0.015 g/cm³ or more, and even more preferably 0.020 cm³, 0.030, 0.040, 0.050, or 0.060 cm³ or more.

The upper limit of the dry density of the formed adsorber may be preferably 0.400 g/cm³ or less, more preferably 0.300 g/cm³ or less, and even more preferably 0.250 g/cm³ or less.

Setting the dry density in the above range enables obtainment of a formed adsorber having more excellent adsorption and desorption performance per volume demanded for use in a canister within a range of volume of the adsorbing material that is able to be stored in the canister. Furthermore, setting the dry density to the above lower limit or higher prevents deterioration of the mechanical properties (for example, the strength) even if the formed adsorber has a sheet shape or a disk shape. Furthermore, the dry density of the formed adsorber can be adjusted, for example, by changing the fiber diameter of the carbon fiber, changing the fiber length through adjustment of stirring force in defibrillation of the carbon fiber, or changing the sucking force in suction forming of the mixed slurry containing the binder, and adjusting the dry density may be one of means for optimizing the adsorption and desorption performance per volume and the pressure loss.

### N-butane Adsorption and Desorption Performance of Formed Adsorber

In an embodiment of the present invention, the formed adsorber preferably has given n-butane adsorption and desorption performance. The n-butane adsorption and desorption performance is an index of adsorption and desorption performance for vapor and adsorbing materials having excellent n-butane adsorption and desorption performance are thus suitable for use in motor vehicle canisters. The n-butane adsorption and desorption performance can be expressed as an effective adsorption-desorption amount ratio for n-butane per formed adsorber, the effective adsorption-desorption amount ratio being determined as an amount of adsorbed n-butane when adsorption is repeated after desorption of n-butane from the adsorbing material under given desorption conditions, the desorption being after sufficient absorption breakthrough of n-butane in the adsorbing material.

A preferred embodiment of the formed adsorber of the present invention is preferably a formed adsorber having an effective adsorption-desorption amount ratio (wt %) for n-butane, the effective adsorption-desorption amount ratio being in a given numerical range. This effective adsorption-desorption amount ratio (wt %) is found according to a measurement method described with respect to Examples below (see Equation 8 below).

A preferred embodiment of the formed adsorber may have an effective adsorption-desorption amount ratio (wt %) for 100% n-butane, the effective adsorption-desorption amount ratio being preferably 30.0 wt % or more, more preferably 35.0 wt % or more, and even more preferably 37.0, 39.0, or 40.0 wt % or more.

A preferred embodiment of the formed adsorber may have an effective adsorption-desorption amount ratio (wt %) for 0.2% n-butane, the effective adsorption-desorption amount ratio being preferably 3.50 wt % or more, more preferably 3.80 wt % or more, and even more preferably 4.00 wt % or more.

Furthermore, a preferred embodiment of the formed adsorber is preferably a formed adsorber having an effective adsorption-desorption ratio (%) for n-butane, the effective adsorption-desorption ratio being in a given numerical range. This effective adsorption-desorption ratio (%) for n-butane is found according to a measurement method described with respect to Examples below (see Equation 9 below).

A preferred embodiment of the formed adsorber may have an effective adsorption-desorption ratio (%) for 100% n-butane, the effective adsorption-desorption ratio being preferably 75.0% or more, more preferably 79.0% or more, and even more preferably 80.0 or 81.0% or more.

A preferred embodiment of the formed adsorber may have an effective adsorption-desorption ratio (%) for 0.2% n-butane, the effective adsorption-desorption ratio being preferably 50.0% or more, more preferably 55.0 or 56.0% or more, and even more preferably 60.0 or 70.0% or more.

### BWC of Formed Adsorber

A preferred embodiment of the formed adsorber of the present invention preferably has butane working capacity (BWC) in a given numerical range. This BWC is found according to a measurement method described with respect to Examples below.

A preferred embodiment of the formed adsorber may have BWC for 100% n-butane, the BWC preferably being 0.4 to 10.0 g/dL.

0-ppm Maintaining Time of Formed Adsorber

A longer 0-ppm maintaining time (for 0.2% n-butane) determined according to a measurement method described with respect to Examples below is generally preferable, but a specific numerical value of the 0-ppm maintaining time in a preferred embodiment of the formed adsorber of the present invention may be preferably 15 minutes or 30 minutes or more, more preferably 40 minutes or more, and even more preferably 50 minutes, 55 minutes, 60 minutes, 65 minutes, 68 minutes, 69 minutes, or 70 minutes or more.

The longer the 0-ppm maintaining time is, the longer it takes for the adsorbing material to start releasing the adsorbed substance. Therefore, the 0-ppm maintaining time is an index of the adsorptivity.

In another embodiment of the present invention, the formed adsorber can be low in pressure loss. The activated carbon fiber itself is a material that is comparatively low in pressure loss among some types of activated carbon available. However, mere activated carbon fiber tends to be easily deformed. Therefore, the present inventors devised mixing the granular activated carbon and the binder into the activated carbon fiber and subjecting the mixture to forming, to improve stability of the shape. At first, the present inventors had expected that though improving the stability of the shape, this forming might either: make the pressure loss become, at the very best, the mean of the pressure loss in a formed product made of the activated carbon fiber and the binder and the pressure loss in that made of the granular activated carbon and the binder; or increase the pressure loss. However, an unexpected formed adsorber, which is a formed product made of a mixture of these three types of materials, was able to be obtained, the unexpected formed adsorber enabling the pressure loss to be smaller than: the pressure loss in the formed product made of the mixture of the two types of materials that are the activated carbon fiber and the binder; or the pressure loss in the formed product of the mixture of the two types of materials that are the granular activated carbon and the binder.

The mechanism of this effect is not necessarily clear but according to one hypothesis, voids may be generated depending on the state of mixing of the different types of materials and these voids may contribute to decrease in the pressure loss, because activated carbon fiber and granular activated carbon are different types of materials in terms of their physical characteristics, such as their shapes, even though they are both activated carbon.

Various conditions for reducing the pressure loss by the mixture of the three types of materials may be available, but adjusting the balance among the amounts of the activated carbon fiber and granular activated carbon to be mixed or the state of mixing of the activated carbon fiber and granular activated carbon is an example of one of such means.

In an embodiment of the present invention, the pressure loss may preferably be 0.05 to 0.52 kPa. More specifically, the pressure loss is as follows.

In an embodiment of the present invention, the upper limit of the pressure loss in the formed adsorber may be preferably 0.52, 0.50, 0.45, or 0.43 kPa or less, more preferably 0.40, 0.38, 0.35, or 0.33 kPa or less, and even more preferably 0.30, 0.28, or 0.25 kPa or less.

This does not simply mean that the lower the pressure loss, the better, and in terms of, for example, the adsorption performance for the intended purpose, the lower limit of the pressure loss may be preferably 0.05 kPa or more, 0.08, or 0.10 kPa or more.

### 2. Shape of Formed Adsorber

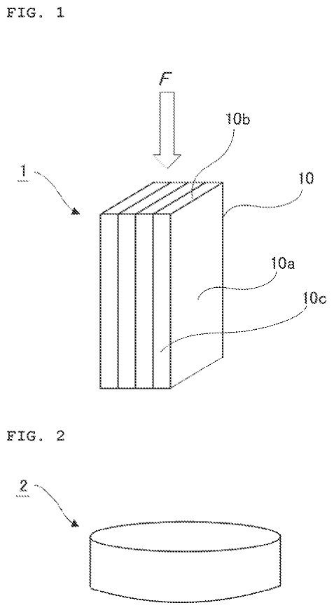

In an embodiment of the present invention, the shape of the formed adsorber is not particularly limited, and for example, a shape that can be molded and enables gas to flow through the formed adsorber is suitable. Specific examples of the shape may include: a column shape having end faces that are circular or polygonal; a frustum shape, such as a truncated cone shape or a prismoid shape; a pellet shape; and a honeycomb shape, and may preferably include cylinder shapes and cuboid shapes. Furthermore, plural disk-shaped, sheet-shaped, or plate-shaped formed adsorbers may be layered over one another to be formed into a layered product. FIG. 1 to FIG. 3 illustrate some embodiments. Dimensions, such as lengths and thicknesses, in the drawings have been schematically illustrated to allow the invention to be readily understood and are thus not limited to those illustrated in the drawings.

A layered adsorber 1 illustrated in FIG. 1 is a layered product formed of four formed adsorber sheets 10 superposed on one another. The sheet-shaped formed adsorbers 10 have been formed by superposition of major surfaces 10a of the sheets on one another. In an embodiment, each of these sheets 10 may be obtained by forming a mixture of activated carbon fiber, granular activated carbon, and a binder into a sheet shape. The binder may preferably be a fibrous binder.

The layered adsorber 1 may be stored in a canister in any way. In a preferred embodiment, the layered adsorber 1 is preferably arranged so that the major surfaces 10a of the sheet-shaped formed adsorbers 10 are not orthogonal to the direction of flow of fluid F, such as vapor, and more preferably, as illustrated in FIG. 1, the layered adsorber 1 may be arranged so that the major surfaces 10a become approximately parallel to the direction of flow of the fluid F, such as vapor. Arranging the major surfaces 10a approximately parallel to the flow direction of the fluid F, such as vapor, places lateral end surfaces 10b of the plural sheet-shaped formed adsorbers 10 to be against the flow direction of the fluid F. This arrangement may reduce pressure loss. In FIG. 1, the lateral end surfaces 10b shorter in length are against the flow direction of the fluid F, but without being limited to this arrangement, longer lateral end surfaces 10c may be arranged to be against the flow direction of the fluid F.

Furthermore, the overall shape of the layered adsorber may be cuboidal or cubical.

FIG. 2 illustrates another embodiment of the present invention. In the embodiment illustrated in FIG. 2, the formed adsorber has been shaped in a disk shape. Such disk-shaped formed adsorbers may be superposed on one another to form a cylinder shape.

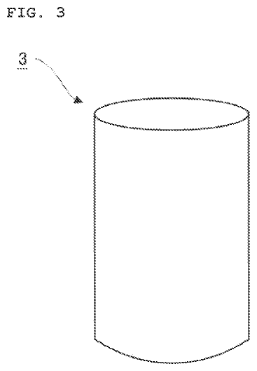

FIG. 3 illustrates another embodiment of the present invention. In the embodiment illustrated in FIG. 3, the formed adsorber has been integrally formed as a cylinder-shaped formed product.

Furthermore, still another embodiment of the present invention may be as follows. Sheets having granular activated carbon adhered to or held on surfaces of activated carbon fiber sheets may be prepared, and the sheets may be attached to each other by use of a binder and formed into a layered adsorber. The layered adsorber may have a structure having the sandwiched granular activated carbon near interfaces between the sheets and the overall appearance of the layered adsorber may be similar to that of the layered adsorber 1 in FIG. 1.

A layered adsorber that is an embodiment of the present invention thus can be readily processed or formed into any of various shapes and is a material having excellent handleability.

### 3. Granular Activated Carbon

In the present disclosure, the granular activated carbon refers to activated carbon having a mean particle size ranging from 100 to 3000 μm.

In an embodiment of the present invention, the granular activated carbon is used as one type of activated carbon. Embodiments of the granular activated carbon that may be used in the present invention will hereinafter be described more in detail. In an embodiment of the present invention, fulfilling at least one or any two or more of given conditions described below enables provision of a more preferred embodiment of the granular activated carbon that may be used in the formed adsorber for canisters. A preferred combination of the given items described below can be selected in any way as desired according to requirements demanded, for example.

### Particle Size Mean Value of Granular Activated Carbon

In an embodiment of the present invention, the granular activated carbon used in the formed adsorber may preferably have a mean particle size ranging from 100 to 3000 μm. More specifically, the mean particle size is as follows.

In an embodiment of the present invention, the lower limit of the particle size mean value of the granular activated carbon used in the formed adsorber may be preferably 100 μm or more, more preferably 120, 140, or 160 um or more, and even more preferably 180 μm or more.

In an embodiment of the present invention, the upper limit of the particle size mean value of the granular activated carbon used in the formed adsorber may be preferably 3000 μm or less, more preferably 2500, 2000, 1500, 1000, or 800 μm or less, and even more preferably 600 μm or less.

In combination with the activated carbon fiber, the granular activated carbon used in the formed adsorber and having the particle size mean value in the above range is suitable for obtainment of a formed adsorber having excellent adsorption and desorption performance for fuel gas (in particular, n-butane) of a wide concentration range from a low concentration to a high concentration. Furthermore, the granular activated carbon having the particle size mean value in the above range is suitable in terms of obtaining a formed adsorber that enables reduction of pressure loss.

### Total Pore Volume of Granular Activated Carbon

In an embodiment of the present invention, the granular activated carbon used in the formed adsorber may preferably have a total pore volume ranging from 0.90 to 2.50 cm³/g. More specifically, the total pore volume is as follows.

In an embodiment of the present invention, the lower limit of the total pore volume of the granular activated carbon used in the formed adsorber may be preferably 0.90 cm³/g or more, more preferably 1.00 cm³/g or more, and even more preferably 1.10, 1.20, or 1.30 cm³/g or more.

In an embodiment of the present invention, the upper limit of the total pore volume of the granular activated carbon used in the formed adsorber may be preferably 2.50 cm³/g or less, more preferably 2.20 or 2.00 cm³/g or less, and even more preferably 1.80, 1.70, or 1.60 cm³/g or less.

In combination with the activated carbon fiber, the granular activated carbon having the total pore volume in the above range is suitable for obtainment of a formed adsorber having excellent adsorption and desorption performance for fuel gas (in particular, n-butane) of a wide concentration range from a low concentration to a high concentration. Setting the total pore volume of the granular activated carbon in the above range may be suitable for improving the adsorption and desorption performance, rather for fuel vapor (in particular, n-butane) high in concentration, in relative comparison with the activated carbon fiber. Setting the total pore volume of the granular activated carbon in the above range is also suitable in terms of obtaining a formed adsorber that enables reduction of pressure loss.

### Mean Pore Size (Mean Pore Diameter) of Granular Activated Carbon

In an embodiment of the present invention, the granular activated carbon contained in the formed adsorber may preferably have a mean pore size ranging from 2.00 to 4.00 nm. More specifically, the mean pore size is as follows.

In an embodiment of the present invention, the lower limit of the mean pore size of the granular activated carbon used in the formed adsorber may be preferably 2.00 nm or more, more preferably 2.10 nm or more, and even more preferably 2.20 or 2.30 nm or more.

In an embodiment of the present invention, the upper limit of the mean pore size of the granular activated carbon used in the formed adsorber may be optional, but may be preferably 4.00 nm or less, more preferably 3.50 nm or less, and even more preferably 3.00 nm or less.

In combination with the activated carbon fiber, the granular activated carbon having the mean pore size in the above range is suitable for obtainment of a formed adsorber having excellent adsorption and desorption performance for fuel gas (in particular, n-butane) of a wide concentration range from a low concentration to a high concentration. Setting the mean pore size of the granular activated carbon in the above range may be suitable for improving the adsorption and desorption performance, rather for fuel vapor (in particular, n-butane) high in concentration, in relative comparison with the activated carbon fiber. Setting the mean pore size of the granular activated carbon in the above range is also suitable in terms of obtaining a formed adsorber that enables reduction of pressure loss.

### Specific Surface Area of Granular Activated Carbon

In an embodiment of the present invention, the granular activated carbon used in the formed adsorber may preferably have a specific surface area ranging from 1400 to 2700 m²/g. More specifically, the specific surface area is as follows.

In an embodiment of the present invention, the lower limit of the specific surface area of the granular activated carbon used in the formed adsorber may be preferably 1400 m²/g or more, more preferably 1450 or 1500 m²/g or more, and even more preferably 1550 or 1600 m²/g or more.

In an embodiment of the present invention, in terms of adsorption performance, the specific surface area of the granular activated carbon used in the formed adsorber is preferably large, but the upper limit of the specific surface area of the granular activated carbon serving as an adsorbing material for canisters may generally be 2700, 2600, or 2500 m²/g or less.

In combination with the activated carbon fiber, the granular activated carbon having the specific surface area in the above range is suitable for obtainment of a formed adsorber having excellent adsorption and desorption performance for fuel gas (in particular, n-butane) of a wide concentration range from a low concentration to a high concentration. Setting the specific surface area of the granular activated carbon in the above range may be suitable for improving the adsorption and desorption performance, rather for fuel vapor (in particular, n-butane) high in concentration, in relative comparison with the activated carbon fiber. Setting the specific surface area of the granular activated carbon in the above range is also suitable in terms of obtaining a formed adsorber that enables reduction of pressure loss.

### Ultramicropore Volume of Granular Activated Carbon: V_{0.7}

In an embodiment of the present invention, the granular activated carbon used in the formed adsorber may preferably have an ultramicropore volume ranging from 0.05 to 0.30 cm³/g. More specifically, the ultramicropore volume is as follows.

In an embodiment of the present invention, the lower limit of the ultramicropore volume of the granular activated carbon used in the formed adsorber may be preferably 0.05 cm³/g or more, more preferably 0.08 cm³/g or more, and even more preferably 0.10 cm³/g or more.

In an embodiment of the present invention, the upper limit of the ultramicropore volume of the granular activated carbon used in the formed adsorber may be preferably 0.30 cm³/g or less, more preferably 0.25 cm³/g or less, and even more preferably 0.23, 0.20, 0.18, or 0.15 cm³/g.

Setting the ultramicropore volume of the granular activated carbon in the above range is suitable for obtaining a formed adsorber that is excellent in terms of adsorption and desorption performance and pressure loss, for example.

### Micropore Volume of Granular Activated Carbon: V_{2.0}

In an embodiment of the present invention, the granular activated carbon used in the formed adsorber may preferably have a micropore volume ranging from 0.40 to 1.00 cm³/g. More specifically, the micropore volume is as follows.

In an embodiment of the present invention, the lower limit of the micropore volume of the granular activated carbon used in the formed adsorber may be preferably 0.40 cm³/g or more, more preferably 0.45, or 0.50 cm³/g or more, and even more preferably 0.55 cm³/g or more.

In an embodiment of the present invention, the upper limit of the micropore volume of the granular activated carbon used in the formed adsorber may be preferably 1.00 cm³/g or less, more preferably 0.90 cm³/g or less, and even more preferably 0.80 cm³/g or less.

Setting the micropore volume of the granular activated carbon in the above range is suitable for obtaining a formed adsorber that is excellent in terms of adsorption and desorption performance and pressure loss, for example.

Pore Volume of Pores Having Pore Size Larger than 0.7 nm and Equal to or Smaller than 2.0 nm: V_{0.7-2.0} (Granular Activated Carbon)

In an embodiment of the granular activated carbon used in the formed adsorber, a pore volume V_{0.7-2.0} of pores having pore sizes larger than 0.7 nm and equal to or smaller than 2.0 nm may preferably be 0.20 to 1.20 cm³/g. More specifically, the pore volume V_{0.7-2.0} is as follows.

In an embodiment of the granular activated carbon used in the formed adsorber, the lower limit of the pre volume V_{0.7-2.0} of the pores having the pore sizes larger than 0.7 nm and equal to or smaller than 2.0 nm may be preferably 0.20 cm³/g or more, more preferably 0.30, 0.36, or 0.40 cm³/g or more, and even more preferably 0.43, 0.45, or 0.50 cm³/g or more.

In an embodiment of the granular activated carbon used in the formed adsorber, the upper limit of the pore volume V_{0.7-2.0} of the pores having the pore sizes larger than 0.7 nm and equal to or smaller than 2.0 nm may be preferably 1.20 cm³/g or less, more preferably 1.00 cm³/g or less, and even more preferably 0.90, 0.80, 0.75, 0.70, 0.65, or 0.60 cm³/g or less.

Setting the pore volume V_{0.7-2.0} of the granular activated carbon in the above range is suitable for obtaining a formed adsorber that is excellent in terms of adsorption and desorption performance and pressure loss, for example.

Ratio of Volume of Ultramicropores to Volume of Micropores: R_{0.7/2.0} (for Granular Activated Carbon)

In an embodiment of the granular activated carbon used in the formed adsorber, the ratio R_{0.7/2.0} of the ultramicropore volume to the micropore volume may preferably be 10.0 to 50.0%. More specifically, the ratio R_{0.7/2.0} is as follows.

In an embodiment of the granular activated carbon used in the formed adsorber, the lower limit of the ratio R_{0.7/2.0} of the ultramicropore volume to the micropore volume may be preferably 10.0% or more, more preferably 12.0% or more, and even more preferably 14.0 or 15.0% or more.

In an embodiment of the granular activated carbon used in the formed adsorber, the upper limit of the ratio R_{0.7/2.0} of the ultramicropore volume to the micropore volume may be preferably 50.0% or less, more preferably 40.0, 30.0, or 25% or less, and even more preferably 20.0% or less.

Setting the ratio R_{0.7/2.0} of the ultramicropore volume of the granular activated carbon in the above range is suitable for obtaining a formed adsorber that is excellent in terms of adsorption and desorption performance and pressure loss, for example.

### Humidity Controlled Density of Granular Activated Carbon (at Temperature of 23° C. and Relative Humidity of 50%)

In an embodiment of the present invention, the granular activated carbon used in the formed adsorber may preferably have a given density. A humidity controlled density may be an index of density. In the present disclosure, a humidity controlled density is a density measured at 23° C. and a relative humidity of 50%.

In an embodiment of the present invention, the granular activated carbon used in the formed adsorber may preferably have a humidity controlled density (density at 23° C. and the relative humidity of 50%) ranging from 0.10 to 0.80 g/cm³. More specifically, the humidity controlled density is as follows.

In an embodiment of the present invention, the lower limit of the humidity controlled density (density at 23° C. and the relative humidity of 50%) of the granular activated carbon used in the formed adsorber may be preferably 0.10 g/cm³ or more, and more preferably 0.15, 0.2, 0.25, or 0.30 g/cm³ or more.

In an embodiment of the present invention, the upper limit of the humidity controlled density of the granular activated carbon used in the formed adsorber may be preferably 0.80 g/cm³ or less, and more preferably 0.70, 0.60, 0.55, 0.50, or 0.45 g/cm³ or less.

Setting the humidity controlled density in the above range under the above condition is suitable for obtaining a formed adsorber that is excellent in terms of adsorption and desorption performance and pressure loss, for example.

### 4. Activated Carbon Fiber

In an embodiment of the present invention, the activated carbon fiber is used as one type of activated carbon. In a preferred embodiment of the present invention, a formed adsorber is exemplified in which the activated carbon fiber has a total pore volume smaller than a total pore volume of granular activated carbon and has a mean pore diameter smaller than a mean pore diameter of the granular activated carbon.

“The total pore volume of the activated carbon fiber being smaller than the value of the total pore volume of the granular activated carbon” does not mean that the total pore volume of the activated carbon fiber is smaller than the lower limit of the numerical range for the granular activated carbon disclosed herein, but means that the total pore volume of the activated carbon fiber is smaller than the value of the total pore volume of the granular activated carbon adopted in the individual formed adsorber. This means, for example, that the value of the total pore volume of the activated carbon fiber may just be less than 1.00 cm³/g in a case where the granular activated carbon contained in the formed adsorber has a total pore volume of 1.00 cm³/g. In the present disclosure, unless otherwise specified, the same applies to the other items including the mean pore diameter.

The granular activated carbon and activated carbon fiber described above are the same in that the granular activated carbon and activated carbon fiber are each one type of activated carbon, but the granular activated carbon and activated carbon fiber may differ from each other in terms of their characteristics, such as their adsorption and desorption performance. There is no sharp line between the roles of the granular activated carbon and activated carbon fiber in the embodiments described above, but a formed adsorber may be prepared so that mainly granular activated carbon has the role in adsorption and desorption of a high concentration of fuel vapor and mainly activated carbon fiber has the role in adsorption and desorption of a low concentration of the fuel vapor.

Embodiments of the activated carbon fiber that may be used in the present invention will hereinafter be described more in detail. Additionally fulfilling at least one or any two or more of given items described below enables provision of a more preferred embodiment of the activated carbon fiber that may be used in the formed adsorber for canisters. A preferred combination of the given items described below can be selected in any way as desired according to requirements demanded, for example.

### Fiber Diameter of Activated Carbon Fiber

In an embodiment of the present invention, the activated carbon fiber used in the formed adsorber may preferably have a fiber diameter ranging from 6.0 to 70.0 μm. More specifically, the fiber diameter is as follows.

In an embodiment of the present invention, the lower limit of the fiber diameter of the activated carbon fiber used in the formed adsorber may be preferably 4.0 μm or more, more preferably 6.0 μm or more, and even more preferably 8.0, 10.0, 12.0, 14.0, 18.0, 19.0, or 20.0 μm or more.

In an embodiment of the present invention, the upper limit of the fiber diameter of the activated carbon fiber used in the formed adsorber may be optional in terms of reduction of pressure loss, but in consideration of balance between the reduction of pressure loss and adsorption and desorption performance, the upper limit may be, for example, 70.0 μm or less, preferably 65.0 or 60.0 μm or less, and more preferably 59.0, 58.0, 57.0, 56.0, or 55.0 μm or less.

The above range of the fiber diameter of the activated carbon fiber that may be used in the formed adsorber is suitable for obtainment of a formed adsorber that is excellent in terms of adsorption and desorption performance and pressure loss, for example.

### Fiber Length Mean Value of Activated Carbon Fiber (or Mean Fiber Length)

In an embodiment of the present invention, the activated carbon fiber used in the formed adsorber may preferably have a fiber length mean value ranging from 300 to 10000 μm. More specifically, the fiber length mean value is as follows.

In an embodiment of the present invention, the lower limit of the fiber length mean value of the activated carbon fiber used in the formed adsorber may be preferably 300 μm or more, more preferably 500, 600, 700, 800, 850, or 900 μm or more, and even more preferably 950 μm or more.

In an embodiment of the present invention, the upper limit of the fiber length mean value of the activated carbon fiber used in the formed adsorber may be preferably 10000, 7500, or 5000 μm or less, more preferably 4000, 3000, 2500, 2000, or 1500 μm or less, and even more preferably 1200 μm or less.

The above range of the fiber length mean value of the activated carbon fiber used in the formed adsorber is suitable for obtainment of a formed adsorber that is excellent in terms of adsorption and desorption performance and pressure loss, for example.

### Fineness of Precursor of Activated Carbon Fiber

To obtain the activated carbon fiber having the above fiber diameter, a fiber diameter (as fineness) of fiber serving as a precursor of the activated carbon fiber is preferably in the following range. That is, adopting the following fiber as the precursor may be said to be suitable for obtaining activated carbon fiber that is excellent in terms of adsorption and desorption performance and pressure loss.

In an embodiment of the present invention, the fiber diameter (as fineness) of the fiber serving as the precursor may preferably be 1.0 to 70.0 dtex. More specifically, the fiber diameter is as follows.

The lower limit of the fiber diameter (as fineness) of the fiber serving as the precursor may be preferably 1.0 dtex or more, more preferably 4.0 or 7.0 dtex or more, and even more preferably 10.0 dtex or more.

The upper limit of the fiber diameter (as fineness) of the fiber serving as the precursor may be, for example, 70.0 dtex or less, preferably 65.0 dtex or less, and more preferably 60.0 dtex.

### Total Pore Volume of Activated Carbon Fiber

In an embodiment of the present invention, the activated carbon fiber used in the formed adsorber may preferably have a total pore volume ranging from 0.50 to 1.20 cm³/g. More specifically, the total pore volume is as follows.

In an embodiment of the present invention, the lower limit of the total pore volume of the activated carbon fiber used in the formed adsorber may be preferably 0.50 cm³/g or more, more preferably 0.60 or 0.70 cm³/g or more, and even more preferably 0.80 cm³/g or more.

In an embodiment of the present invention, the upper limit of the total pore volume of the activated carbon fiber used in the formed adsorber may be preferably 1.20 cm³/g or less, more preferably 1.10 cm³/g or less, and even more preferably 1.00 cm³/g or less.

In combination with the granular activated carbon, the activated carbon fiber having the total pore volume in the above range is suitable for obtainment of a formed adsorber having excellent adsorption and desorption performance for fuel gas (in particular, n-butane) of a wide concentration range from a low concentration to a high concentration. Setting the total pore volume of the activated carbon fiber in the above range may be suitable for improving the adsorption and desorption performance, rather for fuel vapor (in particular, n-butane) low in concentration, in relative comparison with the granular activated carbon. Setting the total pore volume of the activated carbon fiber in the above range is also suitable in terms of obtaining a formed adsorber that enables reduction of pressure loss.

### Mean Pore Size (Mean Pore Diameter) of Activated Carbon Fiber

In an embodiment of the present invention, the activated carbon fiber used in the formed adsorber may preferably have a mean pore size ranging from 1.60 to 4.00 nm. More specifically, the mean pore size is as follows.

In an embodiment of the present invention, the lower limit of the mean pore size of the activated carbon fiber used in the formed adsorber may be preferably 1.60 nm or more, more preferably 1.65 nm or more, and even more preferably 1.70 or 1.73 nm or more.

In an embodiment of the present invention, the upper limit of the mean pore size of the activated carbon fiber used in the formed adsorber may be optional but may be preferably 4.00 or 3.50 nm or less, more preferably 3.00 or 2.50 nm or less, and even more preferably 2.30 or 2.10 nm or less.

In combination with the granular activated carbon, the activated carbon fiber having the mean pore size in the above range is suitable for obtainment of a formed adsorber having excellent adsorption and desorption performance for fuel gas (in particular, n-butane) of a wide concentration range from a low concentration to a high concentration. Setting the mean pore size of the activated carbon fiber in the above range may be suitable for improving the adsorption and desorption performance, rather for fuel vapor (in particular, n-butane) low in concentration, in relative comparison with the granular activated carbon. Setting the mean pore size of the activated carbon fiber in the above range is also suitable in terms of obtaining a formed adsorber that enables reduction of pressure loss.

### Specific Surface Area of Activated Carbon Fiber

In an embodiment of the present invention, the activated carbon fiber used in the formed adsorber may preferably have a specific surface area ranging from 1100 to 2400 m²/g. More specifically, the specific surface area is as follows.

In an embodiment of the present invention, the lower limit of the specific surface area of the activated carbon fiber used in the formed adsorber may be preferably 1100 m²/g or more, more preferably 1200, 1300, 1400, 1500, or 1600 m²/g or more, and even more preferably 1700 or 1800 m²/g or more.

In an embodiment of the present invention, the activated carbon fiber used in the formed adsorber preferably has a wider specific surface area in general in terms of adsorption performance, but for an adsorbing material for canisters, the upper limit of the specific surface area may generally be 2400, 2300, 2200, or 2100 m²/g or less.

In combination with the granular activated carbon, the activated carbon fiber having the specific surface area in the above range is suitable for obtainment of a formed adsorber having excellent adsorption and desorption performance for fuel gas (in particular, n-butane) of a wide concentration range from a low concentration to a high concentration. Setting the specific surface area of the activated carbon fiber in the above range may be suitable for improving the adsorption and desorption performance, rather for fuel vapor (in particular, n-butane) low in concentration, in relative comparison with the granular activated carbon. Setting the specific surface area of the activated carbon fiber in the above range is also suitable for maintaining the specific surface area large and reducing the pressure loss.

### Ultramicropore Volume of Activated Carbon Fiber: V_{0.7}

In an embodiment of the present invention, the activated carbon fiber used in the formed adsorber may preferably have an ultramicropore volume ranging from 0.05 to 0.30 cm³/g. More specifically, the ultramicropore volume is as follows.

In an embodiment of the present invention, the lower limit of the ultramicropore volume of the activated carbon fiber used in the formed adsorber may be preferably 0.05 cm³/g or more, more preferably 0.08 cm³/g or more, and even more preferably 0.10 cm³/g or more.

In an embodiment of the present invention, the upper limit of the ultramicropore volume of the activated carbon fiber used in the formed adsorber may be preferably 0.30 cm³/g or less, more preferably 0.25 cm³/g or less, and even more preferably 0.23, 0.20, 0.18, or 0.15 cm³/g or less.

Setting the ultramicropore volume of the activated carbon fiber in the above range is suitable for obtaining a formed adsorber that is excellent in terms of adsorption and desorption performance and pressure loss, for example.

### Micropore Volume of Granular Activated Carbon: V_{2.0}

In an embodiment of the present invention, the activated carbon fiber used in the formed adsorber may preferably have a micropore volume ranging from 0.40 to 1.00 cm³/g. More specifically, the micropore volume is as follows.

In an embodiment of the present invention, the lower limit of the micropore volume of the activated carbon fiber used in the formed adsorber may be preferably 0.40 cm³/g or more, more preferably 0.50 or 0.55 cm³/g or more, and even more preferably 0.60 or 0.62 cm³/g or more.

In an embodiment of the present invention, the upper limit of the micropore volume of the activated carbon fiber used in the formed adsorber may be preferably 1.00 cm³/g or less, more preferably 0.90 cm³/g or less, and even more preferably 0.80 cm³/g or less.

Setting the micropore volume of the activated carbon fiber in the above range is suitable for obtaining a formed adsorber that is excellent in terms of adsorption and desorption performance and pressure loss, for example.

Pore Volume of Pores Having Pore Size Larger than 0.7 nm and Equal to or Smaller than 2.0 nm: V_{0.7-2.0} (for Activated Carbon Fiber)

In an embodiment of the activated carbon fiber used in the formed adsorber, the pore volume V_{0.7-2.0} of pores having pore sizes larger than 0.7 nm and equal to or smaller than 2.0 nm may preferably be 0.20 to 1.20 cm³/g. More specifically, the pore volume V_{0.7-2.0} is as follows.

In an embodiment of the activated carbon fiber used in the formed adsorber, the lower limit of the pore volume V_{0.7-2.0} of the pores having the pore sizes larger than 0.7 nm and equal to or smaller than 2.0 nm may be preferably 0.20 cm³/g or more, more preferably 0.30, 0.36, or 0.40 cm³/g or more, and even more preferably 0.43, 0.45, 0.47, or 0.49 cm³/g or more.

In an embodiment of the activated carbon fiber used in the formed adsorber, the upper limit of the pore volume V_{0.7-2.0} of the pores having the pore sizes larger than 0.7 nm and equal to or smaller than 2.0 nm may be preferably 1.20 cm³/g or less, more preferably 1.00 cm³/g or less, and even more preferably 0.90, 0.80, 0.75, 0.70, 0.65, or 0.60 cm³/g or less.

Setting the pore volume V_{0.7-2.0} of the activated carbon fiber in the above range is suitable for obtaining a formed adsorber excellent in adsorption and desorption performance, in particular, adsorption and desorption performance for fuel gas (for example, n-butane) low in concentration. Setting the pore volume V_{0.7-2.0} of the activated carbon fiber in the above range is also suitable for obtaining a formed adsorber that is excellent in terms of pressure loss.

### Ratio of Volume of Ultramicropores to Volume of Micropores: R_{0.7/2.0} (for Activated Carbon Fiber)

In an embodiment of the activated carbon fiber used in the formed adsorber, the ratio R_{0.7/2.0} of the ultramicropore volume to the micropore volume may preferably be 15.0 to 60.0%. More specifically, the ratio R_{0.7/2.0} is as follows.

In an embodiment of the activated carbon fiber used in the formed adsorber, the lower limit of the ratio R_{0.7/2.0} of the ultramicropore volume to the micropore volume may be preferably 15.0% or more, more preferably 18.0% or more, and even more preferably 19.0% or more.

In an embodiment of the activated carbon fiber used in the formed adsorber, the upper limit of the ratio R_{0.7/2.0} of the ultramicropore volume to the micropore volume may be preferably 60.0% or less, more preferably 50.0% or less, and even more preferably 40.0, 30.0, or 25.0% or less.

Setting the ratio R_{0.7/2.0} of the ultramicropore volume of the activated carbon fiber in the above range is suitable for obtaining a formed adsorber excellent in adsorption and desorption performance, in particular, adsorption and desorption performance for fuel gas (for example, n-butane) low in concentration. Setting the ratio R_{0.7/2.0} of the ultramicropore volume of the activated carbon fiber in the above range is also suitable for obtaining a formed adsorber excellent in in terms of pressure loss.

In an embodiment of the present invention, the formed adsorber may contain any other component in addition to the activated carbon fiber, the granular activated carbon, and the binder, but any other component is preferably added so that the effect related to the reduction of pressure loss is not hindered or substantial significance of the effect is not lost.

### 5. Canister

The formed adsorber of the present invention is suitable as an adsorbing material to be stored in a motor vehicle canister. That is, the present invention also enables provision of a motor vehicle canister that is another embodiment.

In an embodiment of the present invention, the motor vehicle canister has the above described formed adsorber installed, as an adsorbing material, in the motor vehicle canister. The motor vehicle canister has a structure that is not particularly limited and may have any common structure. For example, the motor vehicle canister may have the following structure.

A canister comprising:
a housing;
an adsorbing material chamber to store an adsorbing material in the housing;
a first opening to connect between the adsorbing material chamber and an engine and allow gas to move between the adsorbing material chamber and the engine;
a second opening to connect between the adsorbing material chamber and a fuel tank and allow gas to move between the adsorbing material chamber and the fuel tank; and
a third opening to open in response to application of a given pressure to the third opening from the adsorbing material chamber or from outside air, connect between the adsorbing material chamber and the outside air, and allow gas to move between the adsorbing material chamber and the outside air.

In an embodiment of the present invention, the above described formed adsorber of the present invention may be used as the adsorbing material for the canister. As described above, because the formed adsorber of the present invention enables reduction of pressure loss, even if the canister is fully filled with the formed adsorber, the pressure loss is able to be reduced more than that in a case where the canister is filled with conventional activated carbon fiber sheets.

The first, second, and third openings are inlet-outlets through which gas is let in and let out. The arrangement of these openings that are inlet-outlets for gas is not particularly limited, but the third opening that is an inlet-output for outside air is preferably arranged at a position enabling gas to sufficiently pass through the adsorbing material when the gas moves between: the third opening; and the first opening and/or second opening. For example, in an embodiment that may be adopted, the first and second openings are provided on a first lateral surface of the housing and the third opening is provided on a second lateral surface located opposite to the first lateral surface.

The adsorbing material chamber may have more than one chamber. For example, the adsorbing material chamber may be divided into two or more sections by a partition wall or partition walls. The partition walls to be used may be porous plates having gas permeability. Furthermore, an additional adsorbing material chamber may be installed by provision of an external second housing separately from the first housing so that the first housing and the second housing are connected to each other via a gas passage. In a case where plural sections or housings are provided as described above, in a preferred embodiment, adsorbing materials or adsorbing material chambers may be arranged so that adsorption capacities in these sections or housings decrease sequentially from one section or housing to the next, from the first or second opening, into which gas from the engine or the fuel tank flows, toward the third opening.

Specific examples may include a composite canister including a main canister (a first housing) and a second canister (a second housing) that is additionally provided to the main canister and that is near the intake for outside air. When plural sections or housings are provided as described above, a high performance canister is able to be provided with reduced cost. Such a high performance canister has: a main body (a first section or a first housing) with the largest storage capacity; and a second or later section or housing with a relatively smaller storage capacity. The main body is a section or housing where vapor from the engine or fuel tank flows into first and conventional and inexpensive activated carbon is to be stored. The second or later section or housing is to store the formed adsorber of the present invention having excellent adsorption and desorption performance for a low concentration.

When there is more than one adsorbing material chamber, fuel vapor flowing, from a preceding layer, into an adsorbing material chamber positioned downstream from the engine or fuel tank (that is, the adsorbing material chamber positioned closer to the inlet-outlet for outside air) has become lower in concentration. Therefore, activated carbon having high n-butane adsorption performance for a low concentration of about 0.2% is suitable as an adsorbing material to be stored in a second section or second housing or a more downstream adsorbing material chamber. This second section or housing or this more downstream adsorbing material chamber is positioned downstream from the engine or fuel tank. Furthermore, use of the activated carbon in the adsorbing material chamber closer to the intake for outside air enables reduction in the amount of leakage of fuel vapor upon long-term stoppage of the motor vehicle because the effective amount of adsorption-desorption by the formed adsorber of the present invention through purging is large. In view of this effect also, the formed adsorber of the present invention is suitable as an adsorbing material to be used in a motor vehicle canister.

Therefore, a preferred embodiment of the canister may be, for example, as follows.

The canister is a canister for a motor vehicle and includes a main chamber and an auxiliary chamber that each store an adsorbing material,
the auxiliary chamber has a volume to store the adsorbing material, the volume being smaller than that of the main chamber, and the auxiliary chamber is arranged at a position closer to an opening connected to outside air than a position of the main chamber with respect to the above opening, and
the adsorbing material of the present invention is stored in the auxiliary chamber.

In the above described embodiment, one main chamber and one auxiliary chamber may be provided, or two or more main chambers and two or more auxiliary chambers may be provided. In a case where three or more adsorbing material chambers are provided, the formed adsorber of the present invention may be stored in at least one adsorbing material chamber of the auxiliary chambers and may preferably be provided in the auxiliary chamber that is closest to the opening connected to the outside air.

### 6. Method of Manufacturing Formed Adsorber

The above described formed adsorber of the present invention can be obtained by forming an adsorbing material into a given shape, the adsorbing material including granular activated carbon and activated carbon fiber. Examples of the granular activated carbon and the activated carbon fiber that may be used include those that satisfy conditions (such as the total pore volume, the mean pore diameter, and the specific surface area) described above as preferred indices.

In an embodiment of the present invention, the formed adsorber can be obtained by mixing and forming activated carbon fiber, granular activated carbon, and a binder together. Furthermore, as another embodiment of the present invention, a layered product may be formed by attaching activated carbon fiber sheets to each other using a binder, the activated carbon fiber sheets having granular activated carbon adhered to surfaces of the activated carbon fiber sheets.

The activated carbon fiber can be manufactured by, for example, carbonizing and activating fiber having a given fiber diameter. Any common methods may be adopted for the carbonizing and activating.

Examples of an embodiment for manufacturing the activated carbon fiber sheet using a precursor sheet (a raw material sheet) will be described below.

### 6-1. Preparation of Raw Material Sheet (Precursor Fiber Sheet)

### Types of Fiber

Examples of fiber forming the raw material sheet may include cellulosic fiber, pitch-based fiber, PAN-based fiber, and phenol resin-based fiber, and preferably include cellulosic fiber.

### Cellulosic Fiber

The cellulosic fiber refers to fiber composed mainly of cellulose and/or a derivative thereof. Origins of cellulose and cellulose derivatives may be any one or more of examples including chemically synthesized products, plant derived cellulose, regenerated cellulose, and cellulose produced by bacteria. Examples of the cellulosic fiber that may be preferably used include: fiber formed of a plant cellulose material obtained from plants, such as trees; and fiber formed of a long fibrous regenerated cellulose material obtained by dissolution of a plant cellulose material (such as cotton or pulp) through chemical treatment. The fiber may contain a component or components, such as lignin and/or hemicellulose.

Examples of raw materials for the cellulosic fiber (the plant cellulose material or regenerated cellulose material) may include: plant cellulose fiber, such as cotton (such as short fiber cotton, medium fiber cotton, long fiber cotton, super long cotton, and ultra super long cotton), hemp, bamboo, kozo, mitsumata, banana, and tunicates; regenerated cellulose fiber, such as cuprammonium rayon, viscose rayon, polynosic rayon, and cellulose made from bamboo; purified cellulose fiber spun by use of organic solvent (N-methylmorpholine N-oxide); and acetate fiber, such as diacetate and triacetate. In terms of availability, at least one selected from cuprammonium rayon, viscose rayon, and purified cellulose fiber is preferable among these examples.

Filaments forming the cellulosic fiber preferably have diameters ranging from 5 to 75 μm and densities ranging from 1.4 to 1.9 g/cm³.

The form of the cellulosic fiber is not particularly limited, and depending on the purpose, the cellulosic fiber prepared into a form of, for example, raw yarn (unprocessed yarn), false twisted yarn, dyed yarn, single yarn, folded yarn, or covering yarn, can be used. Furthermore, in a case where the cellulosic fiber includes two or more kinds of raw materials, the cellulosic fiber may be, for example, blended yarn or blended twisted yarn. Furthermore, the above-mentioned raw materials in various forms may be used alone or in combination of two or more, as the cellulosic fiber. Non-twisted yarn is preferred among the above-mentioned raw materials for both moldability and mechanical strength of the composite material.

### Fiber Sheet

A fiber sheet refers to a sheet obtained by processing a large number of filaments of fiber into a thin and wide sheet and examples of the fiber sheet may include woven fabric, knitted fabric, and nonwoven fabric.

Methods of weaving the cellulosic fiber are not particularly limited, and any common method can be used. Weaves of the woven fabric are not particularly limited either, and any of three foundation weaves, a plain weave, a twill weave, and a satin weave, may be used.

Spaces between warp yarns and between weft yarns of the cellulosic fiber in the woven fabric formed of the cellulosic fiber may be preferably 0.1 to 0.8 mm, more preferably 0.2 to 0.6 mm, and even more preferably 0.25 to 0.5 mm. Furthermore, the woven fabric formed of the cellulosic fiber may have a mass per unit area of preferably 50 to 500 g/m² and more preferably 100 to 400 g/m².

Setting the spaces and the mass per unit area of the cellulosic fiber and the woven fabric formed of the cellulosic fiber in the above ranges enables carbon fiber woven fabric obtained by heat treatment of the woven fabric to have excellent strength.

Methods of manufacturing the nonwoven fabric are also not particularly limited. Examples of the methods may include: a method where a fiber sheet is obtained by use of a dry method or a wet method with the above-mentioned fiber serving as a raw material and having been cut into appropriate lengths; and a method where a fiber sheet is directly obtained from a solution using, for example, an electrospinning method. After the nonwoven fabric is obtained, treatment, such as resin bonding, thermal bonding, spun lacing, or needle punching, may be added for the purpose of bonding the filaments of fiber together.

### 6-2. Catalyst

In Embodiment 1 of a manufacturing method, a catalyst is held by the raw material sheet prepared as described above. The raw material sheet holding the catalyst is carbonized and activated by using gas, such as water vapor, carbon dioxide, or air gas, and a porous activated carbon fiber sheet is thereby able to be obtained. Examples of the catalyst that may be used include a phosphoric acid-based catalyst and an organic sulfonic acid-based catalyst.

### Phosphoric Acid-based Catalyst

Examples of the phosphoric acid-based catalyst may include: oxyacids of phosphorus, such as phosphoric acid, metaphosphoric acid, pyrophosphoric acid, phosphorous acid, phosphonic acid, phosphonous acid, and phosphinic acid; ammonium dihydrogen phosphate, diammonium hydrogen phosphate, triammonium phosphate, dimethyl phosphono propanamide, ammonium polyphosphate, and polyphosphonitrile chloride; and condensation products between: phosphoric acid, tetrakis (hydroxymethyl) phosphonium salt, or tris (1-aziridinyl) phosphine oxide; and urea, thiourea, melamine, guanine, cyanamide, hydrazine, dicyandiamide, or a methylol derivative of any one of these. Preferred examples may include diammonium hydrogen phosphate. One kind of phosphoric acid-based catalyst may be used alone or two or more kinds of phosphoric acid-based catalysts may be used in combination. In a case where the phosphoric acid-based catalyst is used in the form of an aqueous solution, the phosphoric acid-based catalyst in the aqueous solution has a concentration of preferably 0.05 to 2.0 mol/L and more preferably 0.1 to 1.0 mol/L.

### Organic Sulfonic Acid-Based Catalyst

An organic compound having one or more sulfo groups can be used as the organic sulfonic acid. For example, a compound in which a sulfo group is bonded to any of various carbon skeletons of aliphatic series or aromatic series can be used. A preferred organic sulfonic acid-based catalyst has a low molecular weight in terms of handling of the catalyst.

Examples of the organic sulfonic acid-based catalyst may include compounds represented by R-SO₃H where: R is a linear or branched alkyl group having 1 to 20 carbon atoms, a cycloalkyl group having 3 to 20 carbon atoms, or an aryl group having 6 to 20 carbon atoms; and each of the alkyl group, the cycloalkyl group, and the aryl group optionally has a substituent of an alkyl group, a hydroxyl group, or a halogen group. Examples of the organic sulfonic acid-based catalyst may include methanesulfonic acid, ethanesulfonic acid, propanesulfonic acid, 1-hexanesulfonic acid, vinylsulfonic acid, cyclohexanesulfonic acid, p-toluenesulfonic acid, p-phenolsulfonic acid, naphthalenesulfonic acid, benzenesulfonic acid, and camphorsulfonic acid. Methanesulfonic acid may be preferably used among these examples. Furthermore, one kind of these organic sulfonic acid-based catalysts may be used alone, or two or more kinds of these organic sulfonic acid-based catalysts may be used in combination.

In a case where the organic sulfonic acid is used in the form of an aqueous solution, the organic sulfonic acid in the aqueous solution has a concentration of preferably 0.05 to 2.0 mol/L and more preferably 0.1 to 1.0 mol/L.

### Mixed Catalyst

The above-mentioned phosphoric acid-based catalyst and organic sulfonic acid-based catalyst may be mixed and used as a mixed catalyst. The mixing ratio may be adjusted as appropriate.

### Holding of Catalyst

The catalyst is held by the raw material sheet. “Being held” means that the catalyst is kept in contact with the raw material sheet, and the catalyst may be held in any of various forms through, for example, adhesion, adsorption, or impregnation. Methods for the catalyst to be held by the raw material sheet are not particularly limited and include, for example, a method of immersing the raw material sheet in an aqueous solution containing the catalyst, a method of sprinkling an aqueous solution containing the catalyst over the raw material sheet, a method of causing the raw material sheet to be in contact with vapor that is the catalyst that has been vaporized, and a method of mixing the fiber of the raw material sheet into an aqueous solution containing the catalyst to make paper.

A method that can be preferably used for sufficient carbonization is a method of immersing the raw material sheet in an aqueous solution containing the catalyst to impregnate the fiber with the catalyst such that the catalyst reaches the inside of the fiber. The temperature for the immersion in the aqueous solution containing the catalyst is not particularly limited and may preferably be room temperature. The immersion time is preferably 10 seconds to 120 minutes and more preferably 20 seconds to 30 minutes. The immersion allows the fiber forming the raw material sheet to adsorb, for example, 1 to 150% by mass and preferably 5 to 60% by mass, of the catalyst. After the immersion, the raw material sheet is preferably taken out from the aqueous solution and dried. A method of drying the raw material sheet may be, for example, any of methods including a method of leaving the raw material sheet to stand at room temperature or putting the raw material sheet in a dryer. The drying may be performed until the sample no longer changes in weight by evaporation of excess moisture after the sample is removed from the aqueous solution containing the catalyst. For example, in the drying at room temperature, the drying time over which the raw material sheet is left to stand may be 0.5 days or more. When the raw material sheet holding the catalyst almost no longer changes in mass through the drying, the step of carbonizing the raw material sheet holding the catalyst is performed.

### 6-3. Carbonization Treatment

After being prepared, the raw material sheet holding the catalyst is subjected to carbonization treatment. The carbonization treatment for obtaining the activated carbon fiber sheet can be performed according to a common method of carbonizing activated carbon. In a preferred embodiment, the carbonization treatment can be performed as follows.

The carbonization treatment is usually performed under an inert gas atmosphere. According to the present invention, the inert gas atmosphere means an oxygen-free or low-oxygen atmosphere in which carbon is difficult to undergo a combustion reaction and thus carbonization is caused. For example, the inert gas atmosphere may be preferably an atmosphere including gas, such as argon gas or nitrogen gas.

The raw material sheet holding the catalyst is subjected to heat treatment and carbonized in the given gas atmosphere mentioned above.

In an embodiment of the present invention, a heating temperature in the carbonization treatment may preferably be 300 to 1400° C. More specifically, the heating temperature is as follows.

The lower limit of the heating temperature may be preferably 300° C. or higher, more preferably 350° C. or higher, and even more preferably 400° C. or higher or 750° C. or higher.

The upper limit of the heating temperature may be preferably 1400° C. or lower, more preferably 1300° C. or lower, and even more preferably 1200° C. or lower or 1000° C. or lower.

Setting the heating temperature as described above enables obtainment of a carbon fiber sheet with its fiber form maintained. If the heating temperature is lower than the above-mentioned lower limit, the carbon fiber may have a carbon content of 80% or less and carbonization thus tends to be insufficient.

In an embodiment of the present invention, a heat treatment time in the carbonization treatment may preferably be 10 to 180 minutes including the time for the temperature to rise. More specifically, the heat treatment time is as follows.

The lower limit of the heat treatment time including the time for the temperature to rise may be preferably 10 minutes or more, more preferably 11 minutes or more, even more preferably 12 minutes, 15 minutes, 20 minutes, 25 minutes, or more, and still even more preferably 30 minutes or more.

The upper limit of the heat treatment time may be optional, but may be preferably 180 minutes or less, more preferably 160 minutes, and even more preferably 140 minutes or less.

Sufficiently impregnating the raw material sheet with the catalyst, setting the above-mentioned suitable heating temperature, and adjusting the heat treatment time enable adjustment of the degree of progress of pore formation and thus adjustment of the physical properties of the porous body, such as the specific surface area, the volumes of various pores, and the mean pore diameter.

If the heat treatment time is shorter than the above lower limit, carbonization tends to be insufficient.

Furthermore, the heat treatment may include further reheating treatment in a given gas atmosphere after the above described heat treatment (which may be referred to as primary heat treatment). That is, the carbonization treatment may be performed by dividing the heat treatment into two or more stages having different conditions, such as temperature conditions. Performing the primary heat treatment and the reheating treatment under given conditions may enable adjustment of the physical properties, promotion of the carbonization and the subsequent activation, and thus obtainment of an activated carbon fiber sheet having excellent adsorption and desorption performance.

### 6-4. Activation Treatment

In an embodiment of the present invention, activation treatment can be performed, for example, continuously after the above described heat treatment, by supplying water vapor or carbon dioxide and maintaining an appropriate activation temperature for a given time period and the activation treatment enables obtainment of the activated carbon fiber sheet.

In an embodiment of the present invention, a heating temperature in the activation treatment may preferably be 300 to 1400° C. More specifically, the heating temperature is as follows.

The lower limit of the activation temperature may be preferably 300° C. or higher, more preferably 350° C. or higher, and even more preferably 400, 500, 600, 700, or 750° C. or higher.

The upper limit of the activation temperature, on the other hand, may be preferably 1400° C. or lower, more preferably 1300° C. or lower, and even more preferably 1200 or 1000° C. or lower.

In a case where the activation treatment is performed continuously after the heat treatment, the activation temperature is preferably adjusted to a temperature that is almost the same as the heat treatment temperature.

The lower limit of the activation time may be preferably one minute or more, and more preferably five minutes or more.

The upper limit of the activation time may be optional, but may be preferably 180 minutes or less, more preferably 160 minutes or less, and even more preferably 140 minutes or less, 100 minutes or less, 50 minutes or less, or 30 minutes or less.

### 6-5. Obtainment of Granular Activated Carbon

Various types of granular activated carbon are commercially available and any granular activated carbon that is desired can be obtained. Or, granular activated carbon may be prepared by purchasing commercially available activated carbon and additionally subjecting the commercially available activated carbon to treatment, such as crushing and sieving. Or, granular activated carbon may be prepared from, for example, a plant-based material, using a publicly known method.

### 6-6. Manufacture of Formed Product

A method of manufacturing a formed product including activated carbon fiber, granular activated carbon, and a binder is not particularly limited, but the formed product can be obtained by, for example, preparing a mixture of the activated carbon fiber, the granular activated carbon, and the binder and forming the mixture. In an embodiment, for example, the formed product can be manufactured as follows.

### Preparation of Slurry Including Activated Carbon Fiber, Granular Activated Carbon, and Binder

An activated carbon fiber sheet and a binder that have been prepared in advance are mixed into water, are mixed together through defibrillation and dispersion by a stirring means, such as a mixer, and slurry (first slurry) including both the activated carbon fiber sheet and the binder is thereby able to be obtained. The activated carbon fiber sheet to be put into the mixer may be put into the mixer after being made into small pieces having appropriate sizes, depending on the size of the mixer.

Granular activated carbon is added to the first slurry and mixed using a stirring means, such as a spatula, and slurry (second slurry) including the activated carbon fiber, the granular activated carbon, and the binder is thereby able to be obtained. When the granular activated carbon is dispersed therein, the granular activated carbon is preferably stirred gently by, for example, the spatula, such that the granular activated carbon is not crushed.

### Formation of Formed Product

The thus obtained second slurry including the activated carbon fiber, the granular activated carbon and the binder is poured into metal molds having desired shapes, moisture is removed from the poured slurry while the metal molds are being pressed, the molded slurry is thereafter dried, and an adsorber that has been formed is thereby able to be obtained.

### Manufacture of Layered Adsorber

In yet another embodiment of the present invention, a formed adsorber having granular activated carbon sandwiched between activated carbon fiber sheets can be manufactured as follows, for example. Firstly, activated carbon fiber sheets are prepared. Granular activated carbon is adhered to major surfaces of the activated carbon fiber sheets, the major surfaces being surfaces to be attached to each other. For example, mixed slurry including the granular activated carbon and a binder may be prepared and the mixed slurry may be applied to the activated carbon fiber sheets, or simple slurry of the granular activated carbon may be adhered to the activated carbon fiber sheets first and thereafter simple slurry of a binder may be applied to the activated carbon fiber sheets.

### EXAMPLES

The present invention will hereinafter be described more specifically by reference to Examples but the technical scope (or technical range) of the invention presented by the present disclosure is not to be limited to Examples below.

Various items related to physical properties and performance of activated carbon fiber, granular activated carbon, and formed adsorbers were measured and evaluated by methods described below. Various numerical values defining the present invention can be determined by the following measurement methods and evaluation methods.

Basic physical properties related to adsorption performance according to JIS K 1477 were referred to as reference standards for the N2 adsorption BET analysis method related to specific surface areas, total pore volumes, and mean pore diameters. Furthermore, the simulation analysis method by the N2 adsorption Grand Canonical Monte Carlo method (GCMC) was referred to as a reference standard for ultramicropore volumes and micropore volumes.

### Specific Surface Area

About 30 mg of a measurement sample (an activated carbon fiber sheet, granular activated carbon, or a formed adsorber, the same applying hereinafter) were sampled, vacuum-dried at 200° C. for 20 hours, weighed, and then measured using a high-precision gas/vapor adsorption amount measuring apparatus, BELSORP-MAX II (MicrotracBEL Corp.). The amount of nitrogen gas adsorbed at the boiling point of liquid nitrogen (77 K) was measured at a relative pressure ranging from the 10-8 order to 0.990, and an adsorption isotherm of the sample was thereby prepared. This adsorption isotherm was analyzed by the BET method for which the relative pressure range for analysis had been automatically determined under the conditions of the adsorption isotherm of Type I (ISO 9277), and the BET specific surface area per weight (unit: m²/g) was determined as a specific surface area (unit: m²/g).

### Total Pore Volume

The total pore volume (unit: cm³/g) by a one-point method was calculated on the basis of the result at the relative pressure of 0.960 on the adsorption isotherm obtained according to the above section related to the specific surface area.

Mean Pore Size (Mean Pore Diameter); Unit: nm Calculation was performed using Equation 3 below.

$$Mean pore diameter = 4 \times total pore volume \times {10}^{3} \div specific surface area \qquad ( Equation 3 )$$

### Ultramicropore Volume

The adsorption isotherm obtained according to the above section related to the specific surface area was analyzed using the analysis software BELMaster pertaining to the high-precision gas/vapor adsorption amount measuring apparatus, BELSORP-MAX II (MicrotracBEL Corp.) through the GCMC method with the analysis settings set as follows: “Smoothing (moving average processing using one point each before and after every analyzed point of the pore distribution),” “Distribution function: No-assumption,” “Definition of pore size: Solid and Fluid Def. Pore Size,” and “Kernel: Slit-C-Adsorption.” The integrated pore volume at 0.7 nm was read from the obtained pore distribution curve for adsorption and determined as the ultramicropore volume (unit: cm³/g).

### Micropore Volume

The adsorption isotherm obtained according to the above section related to the specific surface area was analyzed using the analysis software BELMaster pertaining to the high-precision gas/vapor adsorption amount measuring apparatus, BELSORP-MAX II (MicrotracBEL Corp.) through the GCMC method with the analysis settings set as follows: “Smoothing (moving average processing using one point each before and after every analyzed point of the pore distribution),” “Distribution function: No-assumption,” “Definition of pore size: Solid and Fluid Def. Pore Size,” and “Kernel: Slit-C-Adsorption.” The integrated pore volume at 2.0 nm was read from the obtained pore distribution curve for adsorption and determined as the micropore volume (unit: cm³/g).

### Basis Weight of Sheet

After the measurement sample (such as an activated carbon fiber sheet) was allowed to stand for 12 hours or more under the environment where the temperature was 23±2° C. and the relative humidity was 50±5%, the basis weight (unit: g/m²) of the sheet was determined from the weight and the lengthwise and widthwise dimensions of the sheet.

### Sheet Thickness

The measurement sample (such as an activated carbon fiber sheet) was allowed to stand for 12 hours or more under the environment where the temperature was 23±2° C. and the relative humidity was 50±5%, and the thickness (unit: mm) of the sheet was then measured using a small digital thickness measuring device, FS-60DS (Daiei Kagaku Seiki Mfg. Co., Ltd.), with a load of 0.3 kPa applied to the sheet.

Humidity Controlled Density of Sheet; Unit: g/cm³

Calculation was performed using Equation 4 below.

$$Sheet density = basis weight of sheet \div sheet thickness \div {10}^{3} \qquad ( Equation 4 )$$

### Moisture in Sheet

The measurement sample (such as an activated carbon fiber sheet) was left to stand for 12 hours or more under the environment where the temperature was 23±2° C. and the relative humidity was 50±5%, 0.5 to 1.0 g of this measurement sample was thereafter collected as a sample and dried at 115+5° C. for three hours or more in a dryer, and moisture (unit: %) was determined from change in weight of the dried sample.

### Measurement of Formed Adsorber

Sizes of the formed adsorber were measured using, for example, vernier calipers and a ruler. The dry weight of the formed adsorber was measured using an electrobalance.

Dry Density of Formed Adsorber; Unit: g/cm³ Calculation was performed using Equation 5 below.

$$Density = \text{} dry weight of formed adsorber \div volume of formed adsorber \qquad ( Equation 5 )$$

The volume of the formed adsorber was calculated from results of the measurement of the formed adsorber.

The term “dry weight” refers to the weight obtained when dried until no further weight change occurs at 115° C. In the following Tables, the weight of “dry basis” also means the weight under the same conditions.

### N-butane Adsorption and Desorption Performance

Tests were conducted for a case where the concentration of n-butane gas was 0.2% and a case where the concentration of n-butane gas was 100%, by reference to Standard Test Method for Determination of Butane Working Capacity of Activated Carbon (ASTM D5228-16) of the American Society for Testing and Materials Standards. In conducting the tests, the flow rate of the n-butane gas and the flow rate of air for desorption were adjusted and set as appropriate by reference to ASTM D5228-16.

(1) Adsorption and Desorption Performance for 0.2% n-Butane Gas

The formed adsorber was dried at 115+5° C. for 3 hours or more in a dryer and the weight of the dried formed adsorber was measured after the dried formed adsorber was cooled. The mass of an empty adsorption container (a stainless-steel frame container that has the same cross-sectional shape as the formed adsorber, allows gas to flow therethrough, and includes an on-off valve at an inlet-outlet of the adsorption container) was measured and the adsorption container was then filled with the formed adsorber.

Subsequently, the adsorption container is placed in a flow apparatus and n-butane gas diluted with air to a concentration of 0.2% is fed into the test tube at 1.0 L/min at a test temperature of 25° C. to cause adsorption of n-butane. The on-off valve of the adsorption container is closed, the adsorption container is removed from the flow apparatus, and the mass is measured. This feeding of the 0.2% n-butane gas was repeated until constant mass was achieved, that is, until the amount of adsorption was saturated.

The adsorption container was reinstalled into the flow apparatus and air was fed into the test tube at a test temperature of 25° C. for 12 minutes at 20.0 L/min to cause desorption of n-butane. The on-off valve of the adsorption container was closed, the adsorption container was removed from the flow apparatus, and the mass was measured.

This adsorption and desorption operation was repeated so as to be performed twice in total, and the first adsorption amount, the effective adsorption-desorption amount, the effective adsorption-desorption amount ratio, and the effective adsorption-desorption ratio were calculated using Equations 6, 7, 8, and 9 below.

$$First adsorption amount = first amount of 0.2 \% n - butane adsorbed \qquad Equation 6$$

The unit of the numerical value is as follows.
First amount of 0.2% n-butane adsorbed (unit: g)

$$Effective adsorption - desorption amount = ( second amount of 0.2 \% n - butane adsorbed + second amount of 0.2 \% n - butane desorbed ) \div 2 \qquad Equation 7$$

The units of the numerical values are as follows.
Effective adsorption-desorption amount (unit: g)
Second amount of 0.2% n-butane adsorbed (unit: g)
Second amount of 0.2% n-butane desorbed (unit: g)

$$Effective adsorption - desorption amount ratio = effective adsorption - desorption amount \div dry weight of formed adsorber \times 100 \qquad Equation 8$$

The units of the numerical values are as follows.
Effective adsorption-desorption amount ratio (unit: wt %)
Effective adsorption-desorption amount (unit: g)
Dry weight of formed adsorber (unit: g)

$$Effective adsorption - desorption ratio = effective adsorption \text{} - \text{} desoption amount \div first adsorption amount \times 100 \qquad Equation 9$$

The units of the numerical values are as follows.
Effective adsorption-desorption ratio (unit: %)
Effective adsorption-desorption amount (unit: g)
First adsorption amount (unit: g)
   Measurement of 0-ppm Maintaining Time

The change in concentration of n-butane at the outlet of the adsorption container upon the feeding of 0.2% n-butane was measured, using a portable gas detector, Cosmotector (model number: XP-3160, manufacturer: New Cosmos Electric Co., Ltd.), every six seconds.

A time over which 0 ppm was maintained continuously from the beginning in second adsorption was determined as a 0-ppm maintaining time (minutes), the second adsorption being after first adsorption and first desorption. This 0 ppm was defined as change in concentration in the second adsorption, the change being less than the quantification lower limit (25 ppm).

(2) Adsorption and Desorption Performance for 100% n-Butane Gas

The adsorption and desorption performance was measured similarly to “(1) Adsorption and Desorption Performance for 0.2% n-Butane Gas” above, except that 100% n-butane gas, instead of 0.2% n-butane gas, was fed at 0.5 L/min and air at 2.0 L/min, instead of air at 20.0 L/min for 12 minutes, was fed for 719× the volume of the formed adsorber (unit: cm³)=2000 minutes.

This adsorption and desorption operation was conducted once in total and the adsorption amount, the effective adsorption-desorption amount, the effective adsorption-desorption amount ratio, the effective adsorption-desorption ratio, and the BWC were calculated using Equations 10, 11, 12, 13, and 14 below.

$$Adsorption amount = amount of 100 \% n - butane adsorbed \qquad Equation 10$$

The unit of the numerical value is as follows.
Amount of 100% n-butane adsorbed (unit: g)

$$Effective adsorption - desorption amount = amount of 100 \% n - butane desorbed \qquad Equation 11$$

The units of the numerical values are as follows.
Effective adsorption-desorption amount (unit: g)
Amount of 100% n-butane desorbed (unit: g)

$$Effective adsorption - desorption amount ratio = effective adsorption - desorption amount \div dry weight of formed adsorber \times 100 \qquad Equation 12$$

The units of the numerical values are as follows.
Effective adsorption-desorption amount ratio (unit: wt %)
Effective adsorption-desorption amount (unit: g)
Dry weight of formed adsorber (unit: g)

$$Effective adsorption - desorption ratio = effective \text{} adsorption - desorption amount \div adsorption amount \times 100 \qquad Equation 13$$

The units of the numerical values are as follows.
Effective adsorption-desorption ratio (unit: %)
Effective adsorption-desorption amount (unit: g)
Adsorption amount (unit: g)

$$Butane working capacity ( BWC ) = effective adsorption - desorption amount \div volume of formed adsorber \times 100 \qquad Equation 14$$

The units of the numerical values are as follows.
BWC (unit: g/dL)
Effective adsorption-desorption amount (unit: g)
Volume of formed adsorber (unit: cm³)

### Measurement of Pressure Loss

Formed adsorbers of Examples, Reference Examples, and Comparative Examples were prepared. A frame body (a frame container) that is a cylindrical container and is open at one end surface and another end surface opposite to that one end surface to allow ventilation therethrough in a direction orthogonal to the end surfaces was prepared as a container to store a shaped adsorber. The end surfaces of the frame container prepared each had a diameter (inner diameter) of 7.7 cm (that is, the areas of the openings at the surfaces were 46.56 cm²). The frame container was fully filled with the formed adsorber prepared and the frame container filled with the formed adsorber was used as a test sample for measurement of pressure loss.

The pressure loss was measured as follows. Air was fed to the test sample prepared as described above at 60 L/min and a result of measurement of differential pressure between the entrance and the exit of the test sample was determined as a pressure loss (kPa), the measurement using a differential pressure meter, testo 510 (Testo K.K.).

### Measurement of Mean Particle Size of Granular Activated Carbon

A median size D50 of a particle size distribution measured using a laser diffraction particle size analyzer, Mastersizer 3000 (Malvern Panalytical Ltd.) was determined as the mean particle size.

### Manufacture of Activated Carbon Fiber (ACF1)

Webbed rayon fiber (56 dtex, a fiber length of 102 mm) having a basis weight of 400 g/m² obtained through a carding machine was impregnated with 6 to 10% diammonium hydrogen phosphate aqueous solution, wrung out, and dried thereafter, to have 8 to 10% by weight of diammonium hydrogen phosphate attached to the fiber. The obtained pretreated nonwoven fabric was heated in a nitrogen atmosphere to 900° C. in 45 minutes and was kept at this temperature for three minutes. Continuously at that temperature, activation treatment was performed for 19 minutes in a nitrogen gas stream containing water vapor with a dew point of 71° C. and activated carbon fiber was thereby obtained.

### Manufacture of Activated Carbon Fiber Sheet (ACF2)

A needle-punched nonwoven fabric made of rayon fiber (17 dtex, a fiber length of 76 mm) and having a basis weight of 400 g/m² was impregnated with 6 to 10% diammonium hydrogen phosphate aqueous solution, wrung out, and dried thereafter, to have 8 to 10% by weight of diammonium hydrogen phosphate attached to the nonwoven fabric. The obtained pretreated nonwoven fabric was heated in a nitrogen atmosphere to 900° C. in 40 minutes and was kept at this temperature for three minutes. Continuously at that temperature, activation treatment was performed for 17 minutes in a nitrogen gas stream containing water vapor with a dew point of 71° C., and an activated carbon fiber sheet was thereby obtained.

### Manufacture of Activated Carbon Fiber Sheet (ACF3)

A needle-punched nonwoven fabric made of rayon fiber (1.7 dtex, a fiber length of 40 mm) and having a basis weight of 400 g/m² was impregnated with 6 to 10% diammonium hydrogen phosphate aqueous solution, wrung out, and dried thereafter, to have 8 to 10% by weight of diammonium hydrogen phosphate attached to the nonwoven fabric. The obtained pretreated nonwoven fabric was heated in a nitrogen atmosphere to 900° C. in 40 minutes and was kept at this temperature for three minutes. Continuously at that temperature, activation treatment was performed for 19 minutes in a nitrogen gas stream containing water vapor with a dew point of 71° C., and an activated carbon fiber sheet was thereby obtained.

### Granular Activated Carbon 1

Formed activated carbon KMAZ3 (manufactured by Shichiseisha) was crushed and the crushed formed activated carbon KMAZ3 that passed a sieve having an opening size of 500 μm of the ISO 3301-1/JIS Z-8801 standards and did not pass a sieve having an opening size of 250 μm of the same standards was obtained as granular activated carbon 1. The mean particle size was 381 μm.

### Granular Activated Carbon 2

Granular activated carbon CW480SZ (manufactured by Futamura Chemical co., Ltd.) was used as granular activated carbon 2. The mean particle size was 352 μm.

### Reference Example 1 (Activated Carbon Fiber: Granular Activated Carbon=100:0)

Into a mixer, 5 parts by weight of a fibrous binder that was acrylic fiber 50TWF manufactured by Japan Exlan Co., Ltd. and 0.5 L of water were put, this mixture was subjected to defibrillation and dispersion for 30 seconds, subsequently, 100 parts by weight of the activated carbon fiber sheet obtained as described above (ACF1) and 0.5 L of water were added to the mixture, the added mixture was subjected to further defibrillation and dispersion for ten seconds, and slurry (first slurry) having the activated carbon fiber that has been defibrillated and dispersed therein was thereby obtained. A metallic cylinder that is able to be divided at a position 24 mm from the bottom of the metallic cylinder and has an inner diameter of 79 mm and a height of 400 mm was placed on a funnel including a porous plate for suction dewatering, the first slurry was poured into the metallic cylinder, and thereafter, suction dewatering was performed from the bottom for forming. A bottom portion of the metallic cylinder was separated, the bottom portion being up to 24 mm from the bottom and containing the moist formed product, the separated metallic cylinder was sandwiched between punching plates at upper and lower cross-sectional surfaces of the separated metallic cylinder, a one-kilogram weight was placed thereon, and the moist formed product was dried at 120° C. for four hours or more in a state of having been squashed to a height of 24 mm if the moist formed product had a height more than 24 mm. The metallic cylinder was removed and an adsorber that has been formed into a disk shape having an outer diameter of 77 mm and a height of 24 mm was obtained. The obtained formed adsorber was more difficult to be deformed than the activated carbon fiber.

### Reference Example 2 (Activated Carbon Fiber: Granular Activated Carbon=100:0)

A formed adsorber having the outer diameter of 77 mm and a height of 24 mm was obtained by a method similar to that in Reference Example 1, except that 100 parts by weight of the activated carbon fiber sheet (ACF2) were used instead of the activated carbon fiber (ACF1) used in Reference Example 1. The obtained formed adsorber was more difficult to be deformed than the activated carbon fiber sheet.

### Reference Example 3 (Activated Carbon Fiber: Granular Activated Carbon=100:0)

A formed adsorber having the outer diameter of 77 mm and the height of 24 mm was obtained by a method similar to that in Reference Example 1, except that 100 parts by weight of the activated carbon fiber sheet (ACF3) were used instead of the activated carbon fiber (ACF1) used in Reference Example 1. The obtained formed adsorber was more difficult to be deformed than the activated carbon fiber sheet.

### Example 1 (Activated Carbon Fiber: Granular Activated Carbon=90:10)

Into a mixer, 5 parts by weight of the fibrous binder used in Reference Example 1 and 0.5 L of water were put, this mixture was subjected to defibrillation and dispersion for 30 seconds, 90 parts by weight of the activated carbon fiber (ACF1) used in Reference Example 1 and 0.5 L of water were added to the mixture, the added mixture was subjected to further defibrillation and dispersion for ten seconds, and first slurry was thereby obtained.

Subsequently, 10 parts by weight of the granular activated carbon 1 was added to the first slurry and stirred using a spatula, and second slurry including the activated carbon fiber and the granular activated carbon dispersed therein was thereby obtained. The second slurry was subjected to suction dewatering by the same method as that in Reference Example 1, dried, and a formed adsorber that had the outer diameter of 77 mm and the height of 24 mm and was disk-shaped was obtained. The obtained formed adsorber was more difficult to be deformed than the activated carbon fiber.

### Example 2 (Activated Carbon Fiber: Granular Activated Carbon=60:40)

A formed adsorber having the outer diameter of 77 mm and the height of 24 mm was obtained by a method similar to that in Example 1, except that 5 parts by weight of the fibrous binder used in Example 1, 60 parts by weight of the activated carbon fiber (ACF1) used in Example 1, and 40 parts by weight of the granular activated carbon 1 used in Example 1 were used. The obtained formed adsorber was more difficult to be deformed than the activated carbon fiber.

### Example 3 (Activated Carbon Fiber: Granular Activated Carbon=30:70)

A formed adsorber having the outer diameter of 77 mm and the height of 24 mm was obtained by a method similar to that in Example 1, except that 5 parts by weight of the fibrous binder used in Example 1, 30 parts by weight of the activated carbon fiber sheet (ACF1) used in Example 1, and 70 parts by weight of the granular activated carbon 1 used in Example 1 were used. The obtained formed adsorber was more difficult to be deformed than the activated carbon fiber.

### Example 4 (Activated Carbon Fiber: Granular Activated Carbon=20:80)

A formed adsorber having the outer diameter of 77 mm and a height of 19 mm was obtained by a method similar to that in Example 1, except that 5 parts by weight of the fibrous binder used in Example 1, 20 parts by weight of the activated carbon fiber sheet (ACF1) used in Example 1, and 80 parts by weight of the granular activated carbon 1 used in Example 1 were used. The obtained formed adsorber was more difficult to be deformed than the activated carbon fiber.

### Example 5 (Activated Carbon Fiber: Granular Activated Carbon=10:90)

A formed adsorber having the outer diameter of 77 mm and a height of 16 mm was obtained by a method similar to that in Example 1, except that 5 parts by weight of the fibrous binder used in Example 1, 10 parts by weight of the activated carbon fiber sheet (ACF1) used in Example 1, and 90 parts by weight of the granular activated carbon 1 used in Example 1 were used. The obtained formed adsorber was more difficult to be deformed than the activated carbon fiber.

### Example 6 (Activated Carbon Fiber: Granular Activated Carbon=60:40)

A formed adsorber having the outer diameter of 77 mm and the height of 24 mm was obtained by a method similar to that in Example 1, except that 5 parts by weight of the fibrous binder used in Example 1, 60 parts by weight of the activated carbon fiber sheet (ACF2) used in Reference Example 2, and 40 parts by weight of the granular activated carbon 1 used in Example 1 were used. The obtained formed adsorber was more difficult to be deformed than the activated carbon fiber sheet.

### Example 7 (Activated Carbon Fiber: Granular Activated Carbon=20:80)

A formed adsorber having the outer diameter of 77 mm and the height of 24 mm was obtained by a method similar to that in Example 1, except that 5 parts by weight of the fibrous binder used in Example 1, 20 parts by weight of the activated carbon fiber sheet (ACF2) used in Example 6, and 80 parts by weight of the granular activated carbon 1 used in Example 1 were used. The obtained formed adsorber was more difficult to be deformed than the activated carbon fiber sheet.

### Example 8 (Activated Carbon Fiber: Granular Activated Carbon=50:50)

A formed adsorber having the outer diameter of 77 mm and the height of 24 mm was obtained by a method similar to that in Example 1, except that 5 parts by weight of the fibrous binder used in Example 1, 50 parts by weight of the activated carbon fiber sheet (ACF3) used in Reference Example 3, and 50 parts by weight of the granular activated carbon 1 used in Example 1 were used. The obtained formed adsorber was more difficult to be deformed than the activated carbon fiber sheet.

### Example 9 (Activated Carbon Fiber: Granular Activated Carbon=20:80)

A formed adsorber having the outer diameter of 77 mm and the height of 24 mm was obtained by a method similar to that in Example 8, except that 5 parts by weight of the fibrous binder used in Example 1, 20 parts by weight of the activated carbon fiber sheet (ACF3) used in Example 8, and 80 parts by weight of the granular activated carbon 1 used in Example 1 were used. The obtained formed adsorber was more difficult to be deformed than the activated carbon fiber sheet.

### Comparative Example 1 (Activated Carbon Fiber: Granular Activated Carbon=90:10)

A formed adsorber having the outer diameter of 77 mm and the height of 24 mm was obtained by a method similar to that in Example 1, except that 5 parts by weight of the fibrous binder used in Example 1, 90 parts by weight of the activated carbon fiber sheet (ACF3) used in Reference Example 3, and 10 parts by weight of the granular activated carbon 2 were used. The obtained formed adsorber was more difficult to be deformed than the activated carbon fiber sheet.

### Comparative Example 2 (Activated Carbon Fiber: Granular Activated Carbon=50:50)

A formed adsorber having the outer diameter of 77 mm and the height of 24 mm was obtained by a method similar to that in Example 1, except that 5 parts by weight of the fibrous binder used in Example 1, 50 parts by weight of the activated carbon fiber sheet (ACF3) used in Comparative Example 1, and 50 parts by weight of the granular activated carbon 2 used in Comparative Example 1 were used. The obtained formed adsorber was more difficult to be deformed than the activated carbon fiber sheet.

### Comparative Example 3 (Activated Carbon Fiber: Granular Activated Carbon=20:80)

A formed adsorber having the outer diameter of 77 mm and the height of 24 mm was obtained by a method similar to that in Example 1, except that 5 parts by weight of the fibrous binder used in Example 1, 20 parts by weight of the activated carbon fiber sheet (ACF3) used in Comparative Example 1, and 80 parts by weight of the granular activated carbon 2 used in Comparative Example 1 were used. The obtained formed adsorber was more difficult to be deformed than the activated carbon fiber sheet.

### Comparative Example 4 (Activated Carbon Fiber: Granular Activated Carbon=0:100)

Into a mixer, 5 parts by weight of the fibrous binder used in Example 1 and 0.5 L of water were put, this mixture was subjected to defibrillation and dispersion for 30 seconds, subsequently, 100 parts by weight of the granular activated carbon 1 used in Example 1 and 0.5 L of water were added to the mixture, the added mixture was stirred with a spatula, and granular activated carbon adsorption slurry was thereby obtained. This adsorption slurry was subjected to suction dewatering by the same method as Example 1, dried, and a formed adsorber that had the outer diameter of 77 mm and a height of 12 mm and was disk-shaped was obtained.

### Comparative Example 5 (Activated Carbon Fiber: Granular Activated Carbon=0:100)

A formed adsorber that had the outer diameter of 77 mm and a height of 22 mm and was disk-shaped was obtained by a method similar to that in Comparative Example 4, except that the granular activated carbon used in Comparative Example 4 was replaced by 100 parts by weight of the granular activated carbon 2.

For each of adsorbing materials for Examples 1 to 9, Reference Examples 1 to 3, and Comparative Examples 1 to 5, measured values were obtained according to the above described measurement methods for the above described items 5 of physical properties. Results of the measurement are listed in Table 1.

Furthermore, characteristics of each of the formed adsorbers of Examples 1 to 9, Reference Examples 1 to 3, and Comparative Examples 1 to 5 are listed in Table 2-1, Table 2-2, Table 2-3, Table 2-4, Table 3-1, Table 3-2, Table 3-3, and Table 3-4. In these tables, the term, “ACF,” is an abbreviation for activated carbon fiber. Furthermore, in these tables, the term, “AC,” is an abbreviation for activated carbon.

TABLE 1
Characteristics of adsorbing materials

| | | | | | | Granular | Granular |
|---|---|---|---|---|---|---|---|
| | | | | | | activated | activated |
| Type of adsorbing material | | | ACF1 | ACF2 | ACF3 | carbon 1 | carbon 2 |
| Fineness of ACF precursor | | dtex | 56 | 17 | 1.7 | — | — |
| N₂ adsorption BET analysis | Specific surface area | m²/g | 2040 | 1850 | 2000 | 2430 | 1660 |
| | Total pore volume | cm³/g | 0.95 | 0.82 | 0.93 | 1.47 | 0.77 |
| | Mean pore diameter | nm | 1.86 | 1.78 | 1.86 | 2.42 | 1.85 |
| N₂ adsorption BET analysis | a)Ultramicropore volume¹⁾ | cm³/g | 0.16 | 0.15 | 0.17 | 0.11 | 0.13 |
| | b)Micropore volume²⁾ | cm³/g | 0.73 | 0.66 | 0.72 | 0.65 | 0.60 |
| | b) − a) | cm³/g | 0.57 | 0.51 | 0.55 | 0.55 | 0.47 |
| | a)/b) | % | 21.3 | 22.7 | 23.6 | 16.4 | 22.3 |

¹⁾Pore size of 0.7 nm or less
²⁾Pore size of 2.0 nm or less

TABLE 2-1
Characteristics of formed adsorbers

| | | | | Reference | Reference | Reference |
|---|---|---|---|---|---|---|
| | | | | Example 1 | Example 2 | Example 3 |
| Fineness of ACF precursor | | | | ACF1 | ACF2 | ACF2 |
| Mixing ratio | Activated carbon fiber | Parts by weight¹⁾ | — | 100 | 100 | 100 |
| | Granular activated carbon | Parts by weight¹⁾ | — | 0 | 0 | 0 |
| | Fibrous binder | Parts by weight¹⁾ | — | 5 | 5 | 5 |

| N₂ adsorption BET analysis | Specific surface area | m²/g | 1943 | 1762 | 1905 |
|---|---|---|---|---|---|
| | Total pore volume | cm³/g | 0.90 | 0.78 | 0.89 |
| | Mean pore diameter | nm | 1.86 | 1.78 | 1.86 |
| N₂ adsorption GCMC analysis | a) Ultramicropore volume²⁾ | cm³/g | 0.15 | 0.14 | 0.16 |
| | b) Micropore volume³⁾ | cm³/g | 0.69 | 0.63 | 0.69 |
| | b) − a) | cm³/g | 0.55 | 0.49 | 0.52 |
| | a)/b) | % | 21.3 | 22.7 | 23.6 |

¹⁾Dry basis
²⁾Pore size of 0.7 nm or less
³⁾Pore size of 2.0 nm or less

TABLE 2-2
Characteristics of formed adsorbers

| | | | | Example 1 | Example 2 | Example 3 | Example 4 | Example 5 |
|---|---|---|---|---|---|---|---|---|
| | | | | ACF1 | ACF1 | ACF1 | ACF1 | ACF1 |
| | | | | Granular | Granular | Granular | Granular | Granular |
| | | | | activated | activated | activated | activated | activated |
| Fineness of ACF precursor | | | | carbon 1 | carbon 1 | carbon 1 | carbon 1 | carbon 1 |
| Mixing ratio | Activated carbon fiber | Parts by weight¹⁾ | — | 90 | 60 | 30 | 20 | 10 |
| | Granular activated carbon | Parts by weight¹⁾ | — | 10 | 40 | 70 | 80 | 90 |
| | Fibrous binder | Parts by weight¹⁾ | — | 5 | 5 | 5 | 5 | 5 |

| N₂ adsorption BET analysis | Specific surface area | m²/g | 1980 | 2091 | 2203 | 2240 | 2277 |
|---|---|---|---|---|---|---|---|
| | Total pore volume | cm³/g | 0.95 | 1.10 | 1.25 | 1.30 | 1.35 |
| | Mean pore diameter | nm | 1.92 | 2.08 | 2.25 | 2.31 | 2.37 |
| N₂ adsorption GCMC analysis | a) Ultramicropore volume²⁾ | cm³/g | 0.14 | 0.13 | 0.12 | 0.11 | 0.11 |
| | b) Micropore volume³⁾ | cm³/g | 0.69 | 0.67 | 0.64 | 0.64 | 0.63 |
| | b) − a) | cm³/g | 0.54 | 0.54 | 0.53 | 0.52 | 0.52 |
| | a)/b) | % | 20.8 | 19.5 | 18.0 | 17.5 | 17.0 |

¹⁾Dry basis
²⁾Pore size of 0.7 nm or less
³⁾Pore size of 2.0 nm or less

TABLE 2-3
Characteristics of formed adsorbers

| | | | | Example 6 | Example 7 | Example 8 | Example 9 |
|---|---|---|---|---|---|---|---|
| | | | | ACF2 | ACF2 | ACF3 | ACF3 |
| | | | | Granular | Granular | Granular | Granular |
| | | | | activated | activated | activated | activated |
| Fineness of ACF precursor | | | | carbon 1 | carbon 1 | carbon 1 | carbon 1 |
| Mixing ratio | Activated carbon fiber | Parts by weight¹⁾ | — | 60 | 20 | 50 | 20 |
| | Granular activated carbon | Parts by weight¹⁾ | — | 40 | 80 | 50 | 80 |
| | Fibrous binder | Parts by weight¹⁾ | — | 5 | 5 | 5 | 5 |

| N₂ adsorption BET analysis | Specific surface area | m²/g | 1983 | 2204 | 2110 | 2232 |
|---|---|---|---|---|---|---|
| | Total pore volume | cm³/g | 1.03 | 1.28 | 1.14 | 1.30 |
| | Mean pore diameter | nm | 2.04 | 2.29 | 2.10 | 2.29 |
| N₂ adsorption GCMC analysis | a) Ultramicropore volume²⁾ | cm³/g | 0.13 | 0.11 | 0.12 | 0.11 |
| | b) Micropore volume³⁾ | cm³/g | 0.63 | 0.62 | 0.62 | 0.62 |
| | b) − a) | cm³/g | 0.50 | 0.51 | 0.50 | 0.51 |
| | a)/b) | % | 20.2 | 17.7 | 19.6 | 17.7 |

¹⁾Dry basis
²⁾Pore size of 0.7 nm or less
³⁾Pore size of 2.0 nm or less

TABLE 2-4
Characteristics of formed adsorbers

| | | | | Comparative | Comparative | Comparative | | |
|---|---|---|---|---|---|---|---|---|
| | | | | Example 1 | Example 2 | Example 3 | Comparative | Comparative |
| | | | | ACF3 | ACF3 | ACF3 | Example 4 | Example 5 |
| | | | | Granular | Granular | Granular | Granular | Granular |
| | | | | activated | activated | activated | activated | activated |
| Fineness of ACF precursor | | | | carbon 1 | carbon 2 | carbon 2 | carbon 1 | carbon 2 |
| Mixing ratio | Activated carbon fiber | Parts by weight¹⁾ | — | 90 | 50 | 20 | 0 | 0 |
| | Granular activated carbon | Parts by weight¹⁾ | — | 10 | 50 | 80 | 100 | 100 |
| | Fibrous binder | Parts by weight¹⁾ | — | 5 | 5 | 5 | 5 | 5 |

| N₂ adsorption BET analysis | Specific surface area | m²/g | 1872 | 1743 | 1646 | 2314 | 1581 |
|---|---|---|---|---|---|---|---|
| | Total pore volume | cm³/g | 0.87 | 0.81 | 0.76 | 1.40 | 0.73 |
| | Mean pore diameter | nm | 1.86 | 1.85 | 1.85 | 2.42 | 1.85 |
| N₂ adsorption GCMC analysis | a) Ultramicropore volume²⁾ | cm³/g | 0.16 | 0.13 | 0.11 | 0.10 | 0.13 |
| | b) Micropore volume³⁾ | cm³/g | 0.67 | 0.63 | 0.60 | 0.62 | 0.60 |
| | b) − a) | cm³/g | 0.52 | 0.50 | 0.48 | 0.52 | 0.47 |
| | a)/b) | % | 23.5 | 21.0 | 19.1 | 16.4 | 22.3 |

¹⁾Dry basis
²⁾Pore size of 0.7 nm or less
³⁾Pore size of 2.0 nm or less

TABLE 3-1

| | | | Combination reference | | |
|---|---|---|---|---|---|
| | | | ACF1 100 | ACF2 100 | ACF3 100 |
| | | | Reference | Reference | Reference |
| | | | Example 1 | Example 2 | Example 3 |
| ACF fiber diameter | | μm | 51.3 | 28 | 10.1 |
| Dry weight | | g | 18.00 | 18.00 | 18.8 |
| Dimensions | Cross-sectional diameter | cm | Φ7.7 | Φ7.7 | Φ7.7 |
| | Length | cm | 2.4 | 2.4 | 2.4 |
| Volume | | cm³ | 111.8 | 111.8 | 111.8 |
| Dry density | | g/cm³ | 0.161 | 0.161 | 0.168 |
| 100% | Adsorption amount | g | 8.2 | 8.2 | 8.2 |
| n-butane | Effective adsorption- | g | 6.3 | 6.3 | 6.4 |
| adsorption- | desorption amount | | | | |
| desorption | Effective adsorption-desorption | wt % | 35.0 | 35.0 | 33.9 |
| performance | amount ratio¹⁾ | | | | |
| | Effective adsorption-desorption | % | 77 | 77 | 78 |
| | ratio²⁾ | | | | |
| | BWC³⁾ | g/dL | 5.6 | 5.6 | 5.7 |
| 0.2% | First adsorption amount | g | 1.82 | 1.82 | 1.83 |
| n-butane | Effective adsorption-desorption | g | 1.05 | 1.05 | 1.05 |
| adsorption- | amount⁴⁾ | | | | |
| desorption | Effective adsorption-desorption | wt % | 5.8 | 5.8 | 5.6 |
| performance | amount ratio⁵⁾ | | | | |
| | Effective adsorption-desorption | % | 58 | 58 | 57 |
| | ratio⁶⁾ | | | | |
| | 0-ppm maintaining time⁷⁾ | min | 150 | 150 | 156 |

| | | | | |
|---|---|---|---|---|
| Pressure loss | kPa | 0.6 | 1.2 | 5.1 |

TABLE 3-2

| | | | Combination reference | | | | |
|---|---|---|---|---|---|---|---|
| | | | ACF1 90 | ACF1 60 | ACF1 30 | ACF1 20 | ACF1 10 |
| | | | AC1 10 | AC1 40 | AC1 70 | AC1 80 | AC1 90 |
| | | | Example 1 | Example 2 | Example 3 | Example 4 | Example 5 |
| ACF fiber diameter | | μm | 51.3 | 51.3 | 51.3 | 51.3 | 51.3 |
| Dry weight | | g | 17.6 | 14.77 | 13.55 | 13.10 | 13.30 |
| Dimensions | Cross-sectional diameter | cm | Φ7.7 | Φ7.7 | Φ7.7 | Φ7.7 | Φ7.7 |
| | Length | cm | 2.4 | 2.4 | 2.4 | 1.9 | 1.6 |
| Volume | | cm³ | 111.8 | 111.8 | 111.8 | 88.5 | 74.5 |
| Dry density | | g/cm³ | 0.157 | 0.132 | 0.121 | 0.148 | 0.179 |
| 100% | Adsorption amount | g | 7.9 | 7.8 | 7.4 | 7.4 | 7.5 |
| n-butane | Effective adsorption- | g | 6.3 | 6.4 | 6.4 | 6.2 | 6.2 |
| adsorption- | desorption amount | | | | | | |
| desorption | Effective adsorption-desorption | wt % | 36.0 | 43.5 | 47.2 | 47.3 | 46.6 |
| performance | amount ratio¹⁾ | | | | | | |
| | Effective adsorption-desorption | % | 80 | 82 | 86 | 84 | 83 |
| | ratio²⁾ | | | | | | |
| | BWC³⁾ | g/dL | 5.7 | 5.8 | 5.7 | 7.0 | 8.3 |
| 0.2% | First adsorption amount | g | 1.8 | 1.08 | 0.93 | 0.81 | 0.79 |
| n-butane | Effective adsorption-desorption | g | 1.0 | 0.75 | 0.67 | 0.60 | 0.61 |
| adsorption- | amount⁴⁾ | | | | | | |
| desorption | Effective adsorption-desorption | wt % | 5.9 | 5.1 | 5.0 | 4.6 | 4.6 |
| performance | amount ratio⁵⁾ | | | | | | |
| | Effective adsorption-desorption | % | 57 | 69 | 73 | 74 | 77 |
| | ratio⁶⁾ | | | | | | |
| | 0-ppm maintaining time⁷⁾ | min | 145 | 123 | 115 | 97 | 95 |

| | | | | | | |
|---|---|---|---|---|---|---|
| Pressure loss | kPa | 0.5 | 0.28 | 0.18 | 0.23 | 0.25 |

TABLE 3-3

| | | | Combination reference | | | |
|---|---|---|---|---|---|---|
| | | | ACF2 60 | ACF2 20 | ACF3 50 | ACF3 20 |
| | | | AC1 40 | AC1 80 | AC1 50 | AC1 80 |
| | | | Example 6 | Example 7 | Example 8 | Example 9 |
| ACF fiber diameter | | μm | 28 | 28 | 10.1 | 10.1 |
| Dry weight | | g | 14.77 | 13.10 | 16.50 | 15.2 |
| Dimensions | Cross-sectional diameter | cm | Φ7.7 | Φ7.7 | Φ7.7 | Φ7.7 |
| | Length | cm | 2.4 | 2.4 | 2.4 | 2.4 |
| Volume | | cm³ | 111.8 | 111.8 | 111.8 | 111.8 |
| Dry density | | g/cm³ | 0.132 | 0.117 | 0.148 | 0.136 |
| 100% | Adsorption amount | g | 7.8 | 7.4 | 7.4 | 7.2 |
| n-butane | Effective adsorption- | g | 6.4 | 6.2 | 6.3 | 6.3 |
| adsorption- | desorption amount | | | | | |
| desorption | Effective adsorption-desorption | wt % | 43.5 | 47.3 | 38.2 | 41.3 |
| performance | amount ratio¹⁾ | | | | | |
| | Effective adsorption-desorption | % | 82 | 84 | 85 | 87 |
| | ratio²⁾ | | | | | |
| | BWC³⁾ | g/dL | 5.8 | 5.5 | 5.6 | 5.6 |
| 0.2% | First adsorption amount | g | 1.08 | 0.81 | 1.14 | 0.83 |
| n-butane | Effective adsorption-desorption | g | 0.75 | 0.60 | 0.78 | 0.62 |
| adsorption- | amount⁴⁾ | | | | | |
| desorption | Effective adsorption-desorption | wt % | 5.1 | 4.6 | 4.7 | 4.1 |
| performance | amount ratio⁵⁾ | | | | | |
| | Effective adsorption-desorption | % | 69 | 74 | 68 | 75 |
| | ratio⁶⁾ | | | | | |
| | 0-ppm maintaining time⁷⁾ | min | 123 | 97 | 120 | 100 |

| | | | | | |
|---|---|---|---|---|---|
| Pressure loss | kPa | 0.36 | 0.3 | 0.91 | 0.4 |

TABLE 3-4

| | | | Combination reference | | | | |
|---|---|---|---|---|---|---|---|
| | | | ACF3 90 | ACF3 50 | ACF3 20 | | |
| | | | AC2 10 | AC2 50 | AC2 80 | AC1 100 | AC2 100 |
| | | | Comparative | Comparative | Comparative | Comparative | Comparative |
| | | | Example 1 | Example 2 | Example 3 | Example 4 | Example 5 |
| ACF fiber diameter | | μm | 10.1 | 10.1 | 10.1 | — | — |
| Dry Weight | | g | 19.50 | 20.40 | 22.10 | 14.50 | 25.97 |
| Dimensions | Cross-sectional diameter | cm | Φ7.7 | Φ7.7 | Φ7.7 | Φ7.7 | Φ7.7 |
| | Length | cm | 2.4 | 2.4 | 2.4 | 1.2 | 2.2 |
| Volume | | cm³ | 111.8 | 111.8 | 111.8 | 55.9 | 102.4 |
| Dry density | | g/cm³ | 0.174 | 0.182 | 0.198 | 0.259 | 0.254 |
| 100% | Adsorption amount | g | 8.3 | 8.5 | 9.0 | 8.9 | 11.1 |
| n-butane | Effective adsorption- | g | 6.1 | 6.1 | 6.1 | 6.2 | 6.5 |
| adsorption- | desorption amount | | | | | | |
| desorption | Effective adsorption- | wt % | 31.3 | 30.1 | 27.8 | 42.9 | 24.9 |
| performance | desorption amount ratio¹⁾ | | | | | | |
| | Effective adsorption- | % | 73 | 73 | 68 | 70 | 58 |
| | desorption amount ratio²⁾ | | | | | | |
| | BWC³⁾ | g/dL | 5.5 | 5.5 | 5.5 | 11.1 | 6.3 |
| 0.2% | First adsorption amount | g | 1.82 | 2.00 | 2.10 | 0.82 | 3.08 |
| n-butane | Effective adsorption- | g | 1.01 | 0.89 | 0.89 | 0.69 | 0.83 |
| adsorption- | desorption amount ratio⁴⁾ | | | | | | |
| desorption | Effective adsorption- | wt % | 5.2 | 4.4 | 4.0 | 4.76 | 3.2 |
| performance | desorption amount ratio⁵⁾ | | | | | | |
| | Effective adsorption- | % | 55 | 45 | 43 | 84 | 27 |
| | desorption amount ratio⁶⁾ | | | | | | |
| | 0-ppm maintaining time⁷⁾ | min | 143 | 96 | 70 | 94 | 44 |

| | | | | | | |
|---|---|---|---|---|---|---|
| Pressure loss | kPa | 3 | 0.93 | 0.48 | 0.53 | 0.91 |

### Annotations in Tables 3-1, 3-2, 3-3, and 3-4

1) (Effective adsorption-desorption amount for 100 n-butane/dry weight of formed adsorber)×100 (wt)
2) (Effective adsorption-desorption amount for 100% n-butane/amount of 100% n-butane adsorbed)×100(%)
3) (Effective adsorption-desorption amount for 100% n-butane/volume of formed adsorber)×100 (g/dl)
4) Mean of second amount of 0.2% n-butane adsorbed and second amount of 0.2% n-butane desorbed
5) (Effective adsorption-desorption amount for 0.2% n-butane/dry weight of formed adsorber)×100 (wt %)
6) (Effective adsorption-desorption amount/first amount of 0.2% n-butane adsorbed)×100(%)
7) 0-ppm maintaining time in second adsorption of 0.2% n-butane

Table 3-1, Table 3-2, Table 3-3, and Table 3-4 evidently show that the formed adsorbers of Examples 1 to 9 have excellent adsorption and desorption performance for both 100% n-butane and 0.2% n-butane.

### LIST OF REFERENCE SIGNS

1 LAYERED ADSORBER
10 SHEET-SHAPED FORMED ADSORBER
10a MAJOR SURFACE OF SHEET-SHAPED FORMED ADSORBER
10b LATERAL END SURFACE OF SHEET-SHAPED FORMED ADSORBER
10c LATERAL END SURFACE OF SHEET-SHAPED FORMED ADSORBER
F FLOW DIRECTION OF GAS
2 DISK-SHAPED FORMED ADSORBER
3 CYLINDER-SHAPED FORMED ADSORBER

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A formed adsorber comprising:
activated carbon fiber, granular activated carbon, and a binder, the formed adsorber being a formed product,
a weight ratio that is 5 to 95 parts by weight of the activated carbon fiber to 95 to 5 parts by weight of the granular activated carbon, in a total weight of the activated carbon fiber and the granular activated carbon;
a content ratio of 0.3 to 20 parts by weight of the binder in the formed adsorber to 100 parts by weight of the activated carbon fiber and the granular activated carbon;
the granular activated carbon having a total pore volume ranging from 0.90 to 2.50 cm³/g; and
the activated carbon fiber having a total pore volume ranging from 0.50 to 1.20 cm³/g.

2. The formed adsorber according to claim 1, wherein the granular activated carbon has a mean pore diameter ranging from 2.00 to 4.00 nm.

3. The formed adsorber according to claim 1, wherein the granular activated carbon has a specific surface area ranging from 1400 to 2700 m²/g.

4. The formed adsorber according to claim 1, wherein
the granular activated carbon has a mean pore diameter ranging from 2.00 to 4.00 nm, and
the granular activated carbon has a specific surface area ranging from 1400 to 2700 m²/g.

5. The formed adsorber according to claim 1, wherein
the total pore volume of the activated carbon fiber is smaller than the total pore volume of the granular activated carbon, and
the activated carbon fiber has a mean pore diameter smaller than a mean pore diameter of the granular activated carbon.

6. The formed adsorber according to claim 1, wherein
the granular activated carbon has a mean pore diameter ranging from 2.00 to 4.00 nm,
the granular activated carbon has a specific surface area ranging from 1400 to 2700 m²/g,
the total pore volume of the activated carbon fiber is smaller than the total pore volume of the granular activated carbon, and
the activated carbon fiber has a mean pore diameter smaller than the mean pore diameter of the granular activated carbon.

7. The formed adsorber according to claim 1, wherein the formed adsorber has a total pore volume ranging from 0.90 to 2.00 cm³/g.

8. The formed adsorber according to claim 1, wherein the formed adsorber has a mean pore diameter ranging from 1.87 to 4.00 nm.

9. The formed adsorber according to claim 1, wherein the weight ratio of the activated carbon fiber to the granular activated carbon, in the total weight of the activated carbon fiber and the granular activated carbon is 5 to 70 parts by weight of the activated carbon fiber to 95 to 30 parts by weight of the granular activated carbon.

10. The formed adsorber according to claim 9, wherein
an effective adsorption-desorption ratio for 100% n-butane is 75.0% or more, and
an effective adsorption-desorption ratio for 0.2% n-butane is 60.0% or more.

11. The formed adsorber according to claim 10, wherein the effective adsorption-desorption ratio for 100% n-butane is 81.0% or more.

12. The formed adsorber according to claim 11, wherein the effective adsorption-desorption ratio for 0.2% n-butane is 70.0% or more.

13. The formed adsorber according to claim 1, wherein the binder is a fibrous binder.

14. The formed adsorber according to claim 9, wherein the binder is a fibrous binder.

15. The formed adsorber according to claim 1, wherein the formed adsorber is used for a canister.

16. The formed adsorber according to claim 9, wherein the formed adsorber is used for a canister.

17. The formed adsorber according to claim 1, wherein the formed adsorber is the formed product configured to be stored in a canister.

18. The formed adsorber according to claim 9, wherein the formed adsorber is the formed product configured to be stored in a canister.
